(19) United States
(12) Patent Application Publication
(10) Pub. No.: US 2022/0175193 A1
(43) Pub. Date: Jun. 9, 2022

(54) FRESH HUMMUS MAKER AND DISPENSER

(71) Applicants: Gidi AMIR, Yokneam Illit (IL); Suf AMIR, Yokneam Illit (IL); Arik ESHEL, Tel Aviv (IL)

(72) Inventors: Gidi AMIR, Yokneam Illit (IL); Suf AMIR, Yokneam Illit (IL); Arik ESHEL, Tel Aviv (IL)

(21) Appl. No.: 17/644,944

(22) Filed: Dec. 17, 2021

Related U.S. Application Data
(63) Continuation-in-part of application No. PCT/IL2020/050587, filed on May 27, 2020.
(60) Provisional application No. 63/129,620, filed on Dec. 23, 2020.
(60) Provisional application No. 62/899,159, filed on Sep. 12, 2019.
(60) Provisional application No. 62/863,285, filed on Jun. 19, 2019.

(51) Int. Cl. A47J 43/07; B01F 27/1123; B01F 27/806; B01F 35/10

(52) U.S. Cl. CPC A47J 43/0705; B01F 35/1452; B01F 27/806; B01F 27/1123

(57) ABSTRACT

The present invention relates to a system and method for preparing and dispensing a puree. The system comprises a blending vessel; a pulping element displaceable within said blending vessel, configured to blend ingredients into a puree. The pulping element is preferably a spinnable blade element displaceable within the interior of the blending vessel.

### FIELD OF THE INVENTION:

The present invention relates to the field of food preparation equipment. More particularly, the present invention relates to a device and method for preparing fresh hummus or other mashes, purees, spreads, pastes, pulps, sauces, dips, smoothies and the like, and its dispensing thereof.

### BACKGROUND OF THE INVENTION:

Hummus is a popular food eaten worldwide and particularly popular in the Middle East. A common meal includes a type of bread (e.g. pita bread) and a hummus dish wherein the bread is dipped in the hummus dish and eaten. Nowadays, hummus is stored and sold in disposable sealable plastic containers in the form of deep dishes comprising substantial volumes for containing the hummus, e.g. in the form of soup bowls.

A Particularly popular form of hummus sold is fresh warm/hot grinded hummus, e.g. grinding recently cooked chickpeas and selling it to be eaten relatively shortly after its preparation (either takeaway or on site). In some cases, if the hummus is not consumed relatively shortly after its preparation there is a threat that it may spoil, e.g. by accumulating bacteria such as Coliform bacteria, Salmonella, etc.

This shortcoming makes it very difficult to prepare large quantities of fresh hummus to be sold in food shops or restaurants. If at every grinding process a large quantity of hummus is prepared and only part of it is shortly sold (to be consumed shortly after its preparation), then the remaining hummus is liable to quickly spoil and thus must be disposed of, what can cause substantial financial losses to the owners of the food shops and restaurants. On the other hand, to prevent large quantity wastes by performing a plurality of small quantity grindings (e.g. for every hummus portion sold) it would necessitate additional manpower to perform the several grinding procedures of small quantities each. This also would require unnecessary additional financial means for the additional manpower.

Similar problems may arise with other substantially liquid foods prepared on sight, dispensed and sold.

Several publications relate to food processing devices such as US 2013081544, WO 2019105181, US 2019176114, CN 106901604 and US 2017039797. However, these publications do not provide adequate and efficient solutions to the shortcomings mentioned herein.

It is therefore an object of the present invention to provide means for preparing fresh hummus that overcome the aforementioned shortcomings.

It is an object of the present invention to provide means for preparation of large quantities of fresh hummus and for their dispensing into doses in an efficient manner, over a large period of time and without spoiling.

It is another object of the present invention to provide means for preparation of large quantities of fresh hummus and for their gradual dispensing into doses, without spoiling and while saving manpower.

Other objects and advantages of the present invention will become apparent as the description proceeds.

### SUMMARY OF THE INVENTION:

The present invention relates to a system and method for preparing and dispensing a puree. The system comprises a blending vessel; a pulping element displaceable within said blending vessel, configured to blend ingredients into a puree. The system may optionally comprise heating elements such that the blended product may be dispensed fresh and hot. The pulping element is preferably a spinnable blade element displaceable within the interior of the blending vessel.

The present invention relates to a system and method for preparing a puree (preferably hummus), preferably maintaining it fresh and dispensing it. The preparation of the puree comprises blending/pulping the raw ingredients (which may be a pre-cooked item, e.g. pre-cooked chickpeas) into a puree. The blending is carried out within a vessel. The vessel may be heated by means of heating elements attached thereon. The raw ingredients are preferably delivered to the vessel by means of valves and transport paths. The puree may be dispensed by usage of one or more of the following: valves, discharge openings and transport paths.

The present invention comprises a pulping element configured to blend/crush ingredients into a soft puree. According to one embodiment, the pulping element is a spinnable blade element as explained herein. According to another element, the pulping element is a mashing element as explained herein.

The present invention relates to a system for preparing and dispensing a puree comprising:
a blending vessel;
a pulping element displaceable within said blending vessel, configured to blend ingredients into a puree;
wherein the bottom of said blending vessel comprises a first valve.
Optionally, the system comprises one or more heating elements attached to the blending vessel.
Optionally, the blending vessel does not comprise a heating element attached thereon.

According to a preferred embodiment, the pulping element is a spinnable blade element placed within the interior of said blending vessel (and is displaceable within the blending vessel as it is spinnable therein).

Preferably, the blade element is fixed to an upper arm element.

Preferably, the system further comprises a cup element comprising an open top portion which is attached to the external side of the bottom surface of the blending vessel; wherein said cup element surrounds the first valve and said cup element's interior is beneath said first valve.

Preferably, the bottom surface of the cup element comprises a second valve.

Preferably, the blending vessel comprises a level sensor.

Preferably, the system further comprises one or more ingredient containers placed above the blending vessel.

Preferably, each one or more ingredient container comprises an ingredient container valve at its bottom surface;

wherein said system comprises a transport path for each of the one or more ingredient containers extending from its respective ingredient container valve to a spatial area above the blending vessel or within the blending vessel.

Preferably, each of the one or more ingredient containers comprises a respective level sensor.

Preferably, the system further comprises a water hose comprising an end piece comprising a plurality of nozzles.

Preferably, the end piece is placed above the blending vessel and beneath the transport paths.

Preferably, the system arm element comprises a motor configured to rotate the blade element.

Preferably, at least one ingredient container comprises heating elements.

Preferably, the at least one container comprising the heating elements is a pressure cooker.

Preferably, the system further comprises an external housing comprising an opening leading to a cavity for placing a receiving dish therein, wherein a portion of the cavity is beneath the second valve.

Preferably, a horizontal conveyor extends from within the cavity outwards.

Preferably, the system further comprises a sliding door (optionally transparent) at the opening of the cavity.

Preferably, the first valve comprises a sliding gate and a flexible sealing O-ring element;

wherein the sliding gate is configured to be placed in a valve closed position and in a valve open position;

wherein the vessel comprises a bottom opening;

wherein the O-ring is mounted on the bottom opening of said vessel; and

wherein when said sliding gate is in the closed position, said O-ring element is compressed and applies force on the top surface of said sliding gate, thereby providing a sealed passageway between the interior of said vessel and the top of said sliding gate.

When the sliding gate is open, the puree within the interior of the blending vessel may exit the blending vessel via the O-ring.

Preferably, the system further comprises a piston unit comprising an internal motor driving a piston rod;

wherein the sliding gate is slidable along tracks; and

wherein the piston rod is connected to the sliding gate.

Preferably, the piston rod is connected to the sliding gate by means of a connecting element.

Preferably, said system further comprises one or more ingredient containers placed above the blending vessel;

wherein each one or more ingredient container comprises an ingredient container valve at its bottom surface that comprises a sliding gate and a flexible sealing O-ring element;

wherein the sliding gate is configured to be placed in a valve closed position and in a valve open position;

wherein each one or more ingredient container comprises a bottom opening;

wherein the O-ring is mounted on the bottom opening of said one or more ingredient container; and

wherein when said sliding gate is in the closed position, said O-ring element is compressed and applies force on the top surface of said sliding gate, thereby providing a sealed passageway between the interior of said one or more ingredient container and the top of said sliding gate. When the sliding gate is open, the ingredients within the respective container exit the respective container via the O-ring.

Preferably, the system further comprises a piston unit comprising an internal motor driving a piston rod;

wherein the sliding gate is slidable along tracks; and

wherein the piston rod is connected to the sliding gate.

Preferably, the piston rod is connected to the sliding gate by means of a connecting element.

Preferably, said system comprises a funnel element extending diagonally upwards from a portion of the vessel rim; and

wherein the ingredient container valves are placed above the interior space of the vessel (in the spatial area above the vessel) or above said funnel element (in the spatial area above the funnel element).

Preferably, the blade element comprises one of the following: (a) two sharp edges; (b) two blunt edges; or (c) a sharp edge and a blunt edge; and

wherein the blade element is spinnable in a forward direction and in a backward direction.

Preferably, the blade element comprises two rotatable blades and a third smaller bottom rotatable blade.

Preferably, any one of the two rotatable blades and third smaller bottom rotatable blade each comprise one of the following: (a) two sharp edges; (b) two blunt edges or (c) a sharp edge and a blunt edge; and

wherein the blade element is spinnable in a forward direction and in a backward direction.

Preferably, the system further comprises:

a motor for driving the rotation of the blade element;

a first pulley mounted on a first spinning axle spinnable by said motor;

a second pulley mounted on a second spinning axle;

a timing belt mounted on said first pulley and said second pulley;

a coupling element comprising an upper coupling portion and a lower coupling portion;

wherein said lower coupling portion is mounted on an upper portion of the upper arm element;

wherein the upper coupling portion is connected to said second spinnable axle and vertically displaceable thereon between a high vertical position and a low vertical position; and

wherein said upper coupling portion is connectable to the lower coupling portion.

Preferably, the upper coupling portion comprises a first group of recesses and a first group of bulging elements protruding downwards, and the lower coupling portion comprises a second group of recesses and a second group of bulging elements protruding upwards; and

wherein when the upper coupling portion is connected to the lower coupling portion:
a) the upper coupling portion first group of bulging elements are placed at corresponding recesses of the lower coupling portion second group of recesses and are complementary thereto; and
b) the lower coupling portion second group of bulging elements are placed at corresponding recesses of the upper coupling portion first group of recesses and are complementary thereto.

In other words, each bulging element of the first group of bulging elements (in the upper coupling portion) is placed at a corresponding recess of the second group of recesses (in the lower coupling portion) and is complementary to that particular recess that it is placed at. Also, each bulging element of the second group of bulging elements (in the lower coupling portion) is placed at a corresponding recess of the first group of recesses (in the upper coupling portion) and is complementary to that particular recess that it is placed at.

Preferably, the upper coupling portion is part of a spring latch mechanism.

Preferably, the second spinning axle comprises a vertical slit; and wherein the upper coupling portion comprises a horizontal rod fixed thereon and placed through said vertical slit.

Preferably, when the upper coupling portion is placed at the high vertical position:
a) the vessel is removable from said system; and
b) the vessel is (thereafter) insertable to said system by being mounted on corresponding fittings.

Also, a second identical vessel (typically clean) may replace the (first) removed (typically dirty) vessel.

Preferably, said system further comprises one or more ingredient container(s) placed above the blending vessel;

wherein the one or more ingredient container(s) comprises an ingredient container valve at its bottom surface;

wherein said one or more ingredient container(s) are aseptic packages.

Preferably, said system further comprises a payment device.

Preferably, said system further comprises a weighing scale.

Preferably, the system comprises a mashing unit comprising:
a vertical arm configured to expand and contract vertically; and
a bottom mashing element connected to the bottom of said vertical arm and configured to be vertically displaceable within the interior of said blending vessel; and

wherein the pulping element is said mashing element.

Preferably, the bottom mashing element is in the form of a flat sheet.

Preferably, the mashing element comprises a plurality of apertures.

Preferably, the system further comprises one or more ingredient containers placed above the blending vessel;

wherein at least one of said one or more ingredient containers comprises:
a first valve assembly separating between an upper portion and a lower portion of the interior space of the one or more ingredient containers; and
a lower valve assembly at its bottom.

Preferably, said system comprises a steam unit coupled to the interior of the one or more ingredient containers.

Preferably, said system further comprises a vibrating surface.

Preferably, the blending vessel is placed within a temperature adjusting chamber wherein said system further comprises a temperature adjusting unit coupled to the interior of said temperature adjusting chamber; and

wherein the temperature adjusting unit is an air heating unit or an air cooling unit.

Preferably, at least one of said one or more ingredient containers comprises a mixing element.

Preferably, the mixing element is an elongated spiral assembly.

Preferably, the elongated spiral assembly comprises an elongated cylinder element and a spiral element mounted thereon such that said cylinder element and said spiral element have a common central axis;

wherein the elongated spiral assembly is mounted between two opposing side wall portions of the one or more containers and is configured to rotate around said common central axis.

Preferably, the spiral element is flat.

Preferably, the spiral assembly engages the one or more container side walls along its length.

Preferably, the spiral assembly separates between an upper portion and a lower portion of the interior space of the one or more ingredient containers.

Preferably, the spiral assembly is placed at the bottom of the one or more containers.

Preferably, the mixing element comprise heating elements attached thereon.

Preferably, said system comprises a steam unit coupled to the interior of the one or more ingredient containers.

Preferably, said system further comprises one or more cartridges each placed above the blending vessel or above a respective ingredient container;

wherein said one or more cartridges comprises a mixing element.

Preferably, the mixing element is an elongated spiral assembly.

Preferably, the elongated spiral assembly comprises an elongated cylinder element and a spiral element mounted thereon such that said cylinder element and said spiral element have a common central axis;

wherein the elongated spiral assembly is mounted between two opposing side wall portions of the one or more cartridges and is configured to rotate around said common central axis.

Preferably, the spiral element is flat.

Preferably, the spiral assembly engages one or more cartridge side walls along its length.

Preferably, the spiral assembly is placed at the bottom of the one or more cartridges.

Preferably, the mixing element comprises:
a spinning bar fixedly mounted on a spinnable axle;
at least one receptacle having an opening and a hollow interior, each receptacle
fixedly connected to one edge of the spinning bar;

wherein the cartridge comprises a bottom valve having an opening; and

wherein the at least one receptacle opening is configured to face and surround the valve opening, when the spinning bar is in a certain spin position.

Preferably, the mixing element comprises heating elements attached thereon.

Preferably, said system comprises a steam unit coupled to the interior of the one or more cartridges.

Preferably, said system comprises one or more heating elements attached to the blending vessel (e.g., by means of the heating unit 302 as explained herein).

The present invention relates to a system for preparing and dispensing a puree comprising:
a blending vessel;
a pulping element displaceable within said blending vessel, configured to blend ingredients into a puree;
wherein the bottom of said blending vessel comprises a first valve;

wherein the blending vessel is placed within a temperature adjusting chamber wherein said system further comprises a temperature adjusting unit coupled to the interior of said temperature adjusting chamber;

wherein the temperature adjusting unit is an air heating unit or an air cooling unit.

The present invention relates to a system for preparing and dispensing a puree comprising:
a blending vessel;
a pulping element displaceable within said blending vessel, configured to blend ingredients into a puree;
wherein the bottom of said blending vessel comprises an opening coupled to a faucet or valve.
Optionally, the system comprises one or more heating elements attached to the blending vessel.
Optionally, the blending vessel does not comprise a heating element attached thereon.

Preferably, the pulping element is a spinnable blade element placed within the interior of said blending vessel.

Preferably, the system comprises a mashing unit comprising:
a vertical arm configured to expand and contract vertically; and
a bottom mashing element connected to the bottom of said vertical arm and configured to be vertically displaceable within the interior of said blending vessel;

wherein the pulping element is said mashing element.

Preferably, the system further comprises one or more ingredient containers placed above the blending vessel;

wherein at least one of said one or more ingredient containers comprises:
a first valve assembly separating between an upper portion and a lower portion of the interior space of the one or more ingredient containers; and
a lower valve assembly at its bottom.

The present invention relates to a system for preparing and dispensing a puree comprising:
a blending vessel;
a pulping element displaceable within said blending vessel, configured to blend ingredients into a puree;
wherein the bottom of said blending vessel comprises an opening coupled to a faucet or valve;

wherein said system further comprises one or more ingredient containers placed above the blending vessel;

wherein at least one of said one or more ingredient containers comprises a mixing element.

Preferably, the mixing element is an elongated spiral assembly;

wherein the elongated spiral assembly comprises an elongated cylinder element and a spiral element mounted thereon such that said cylinder element and said spiral element have a common central axis;

wherein the elongated spiral assembly is mounted between two opposing side wall portions of the one or more containers and is configured to rotate around said common central axis.

The present invention relates to a system for preparing and dispensing a puree comprising:
a blending vessel;
a pulping element displaceable within said blending vessel, configured to blend ingredients into a puree;
wherein the bottom of said blending vessel comprises an opening coupled to a faucet or valve;

wherein said system further comprises one or more cartridges each placed above the blending vessel or above a respective ingredient container;

wherein said one or more cartridges comprises a mixing element.

Preferably, the mixing element is an elongated spiral assembly;

wherein the elongated spiral assembly comprises an elongated cylinder element and a spiral element mounted thereon such that said cylinder element and said spiral element have a common central axis;

wherein the elongated spiral assembly is mounted between two opposing side wall portions of the one or more cartridges and is configured to rotate around said common central axis.

Preferably, the mixing element comprises:
a spinning bar fixedly mounted on a spinnable axle;
at least one receptacle having an opening and a hollow interior, each receptacle fixedly connected to one edge of the spinning bar;

wherein the cartridge comprises a bottom valve having an opening; and

wherein the at least one receptacle opening is configured to face and surround the valve opening, when the spinning bar is in a certain spin position.

The present invention relates to a method for preparing and dispensing a puree comprising the following steps:

A) placing one or more ingredient dosages into a vessel to be blended in a blending cycle;

B) blending the one or more ingredient dosages inside the vessel into a puree;

C) periodically dispensing a dosage of the puree content of step B;

D) periodically placing a consecutive group of one or more ingredient dosages into the vessel to be blended in a consecutive blending cycle and blending the consecutive group of one or more ingredient dosages inside the vessel into a puree, and returning to step C. The method may or may not comprise heating the vessel.

Preferably, the method further comprises a step after step B comprising:

heating or cooling the vessel such that its puree content is heated or cooled (e.g. by the temperature adjusting unit as explained herein, or by heating elements attached to the vessel as explained herein).

Preferably, the method comprises:

providing that the blending vessel is placed in a temperature adjusting chamber, heating or cooling the vessel by means of an air heating/cooling unit coupled to the interior of said temperature adjusting chamber, such that the puree content is heated/cooled.

Preferably, the heating or cooling step is carried out simultaneously during one or more of the other steps.

Preferably, dispensing a dosage of puree from the vessel may be carried out simultaneously during or after either one of steps A and B (or the heating or cooling step as described herein).

Preferably, step D is carried out when either of the following conditions are met:
a) when the puree content of step B is all dispensed;
b) when the puree content of step B is almost all dispensed.

Preferably, the method further comprises a step after step B comprising:

heating or cooling the vessel such that its puree content is heated or cooled. For example, this step may be implemented by means of heating elements attached to the vessel.

Preferably, step A comprises transferring each of the one or more ingredient dosages from a corresponding container to the vessel.

Preferably, said transferring comprises rotating a respective spiral assembly within a corresponding ingredient container.

Preferably, the amount of a respective ingredient dosage transferred from the one or more ingredient dosages is proportional to the rotating of the respective spiral assembly.

Preferably, the method further comprises a step prior to step A comprising:

transferring at least one of said ingredient dosages from a respective cartridge into the corresponding container by rotating a spiral assembly within said respective cartridge.

Preferably, the method further comprises a step prior to step A comprising:

transferring at least one of said ingredient dosages from a respective cartridge into the corresponding container by the following steps:
providing the cartridge having a spinning bar and at least one receptacle having an opening and a hollow interior, each receptacle fixedly connected to one edge of the spinning bar;
providing the cartridge comprises a bottom valve having an opening; and
spinning the spinning bar until the opening faces and surrounds the valve opening;
opening the valve (and typically after the content drops—closing the valve).

Preferably, the puree in steps B and D are hummus products.

Preferably, step C is carried out after payment is made to a corresponding payment device.

Preferably, the vessel is periodically removed and replaced by another vessel.

Preferably, the dispensing in step C is carried out until the dispensed puree reaches a predetermined weight.

Preferably, the dispensed puree dosage is leveled by vibrating the puree.

Preferably, a step is carried out prior to step A comprising:

heating the ingredients within the container by means of a steam unit coupled to the interior of the container.

Preferably, a step is carried out prior to step A comprising:

heating the ingredients within the container by means of heating elements.

Preferably, a step is carried out prior to step A comprising:

heating the ingredients within the container by means of heating elements attached to the container spiral assembly.

Preferably, the method further comprises a step prior to transferring at least one of said ingredient dosages from a respective cartridge into the corresponding container, comprising:

heating the ingredients within the cartridge by means of a steam unit coupled to the interior of the cartridge.

Preferably, the method further comprises a step prior to transferring at least one of said ingredient dosages from a respective cartridge into the corresponding container, comprising:

heating the ingredients within the cartridge by means of heating elements attached to the cartridge spiral assembly.

According to another aspect of the present invention, an arm element comprising a blade element at its end is configured to maneuver the blade element between a cleansing vessel and the interior of a serving dish. The ingredients are transferred to the serving dish prior to the blending.

According to this aspect, the present invention relates to a system for preparing and dispensing a puree comprising:

a spinnable blade element fixed to the end of an arm element;

one or more ingredient containers comprising an ingredient container valve at its bottom surface;

a transport path for each of the one or more ingredient containers extending from its respective ingredient container valve to a first spatial area above a second spatial area (the interior of a serving dish);

a water container;

wherein the arm element is configured to move the blade element between two positions:
a. a first position such that the blade element is located within said second spatial area; and
b. a second position such that the blade element is located within the interior of said water container.

Preferably, at least one of the one or more ingredient containers comprises a mixing element.

Preferably, the mixing element is an elongated spiral assembly;

wherein the elongated spiral assembly comprises an elongated cylinder element and a spiral element mounted thereon such that said cylinder element and said spiral element have a common central axis;

wherein the elongated spiral assembly is mounted between two opposing side wall portions of the one or more containers and is configured to rotate around said common central axis.

Preferably, said system further comprises one or more cartridges each placed above a respective ingredient container;

wherein said one or more cartridges comprises a mixing element.

Preferably, the mixing element is an elongated spiral assembly;

wherein the elongated spiral assembly comprises an elongated cylinder element and a spiral element mounted thereon such that said cylinder element and said spiral element have a common central axis;

wherein the elongated spiral assembly is mounted between two opposing side wall portions of the one or more cartridges and is configured to rotate around said common central axis.

Preferably, the mixing element comprises:
a spinning bar fixedly mounted on a spinnable axle;
at least one receptacle having an opening and a hollow interior, each receptacle
fixedly connected to one edge of the spinning bar;

wherein the cartridge comprises a bottom valve having an opening; and

wherein the at least one receptacle opening is configured to face and surround the valve opening, when the spinning bar is in a certain spin position.

Preferably, at least one of said one or more ingredient containers comprises:
a first valve assembly separating between an upper portion and a lower portion of the interior space of the one or more ingredient containers; and
a lower valve assembly at its bottom.

The serving dish (e.g. a bowl, a hollow container) may also be considered as a blending vessel.

Preferably, the second spatial area is in the interior of a serving dish.

Preferably, the arm element comprises a motor configured to rotate the blade element.

Preferably, the arm element comprises a substantially vertical portion and a substantially horizontal portion;

wherein the substantially horizontal portion is a telescopic arm configured to expand and contract horizontally; and

wherein the substantially vertical portion is a telescopic arm configured to expand and contract vertically.

Preferably, the expansion and contraction of the substantially vertical portion is based on a hydraulic mechanism; and

wherein the expansion and contraction of the substantially horizontal portion is based on a hydraulic mechanism.

Preferably, the system further comprises a lid mounted on the arm element at a distance above the blade element wherein the arm element passes through the center of said lid.

Preferably, the system comprises a drainage hose extending from a dedicated valve at the bottom of the water container; and

a water hose configured to fill the water container with fresh water.

Preferably, the system comprises a drainage hose extending from a dedicated valve at the bottom of the water container; and

a water hose with a plurality of nozzles that face the blade element.

Preferably, each of the one or more ingredient containers comprises a respective level sensor.

Preferably, at least one ingredient container comprises heating elements.

Preferably, the at least one container comprising the heating elements is a pressure cooker.

Preferably, the system further comprises an external housing comprising an opening leading to a cavity for placing a receiving dish therein, wherein a portion of the cavity is the second spatial area.

Preferably, a horizontal conveyor extends from within the cavity outwards.

Preferably, the system further comprises a sliding door (optionally transparent) at the opening of the cavity.

This aspect of the present invention also includes a corresponding method. The present invention relates to a method for preparing and dispensing a puree in a plurality of dispensing cycles, wherein each cycle comprises the following steps:

A) transferring one or more ingredient dosages, each from a respective ingredient container, into a serving dish to be blended in a blending cycle;

B) maneuvering a blade element fixed to the end of an arm element, into the interior of said serving dish;

C) blending the one or more ingredients inside the serving dish into a puree;

D) maneuvering the blade element, into the interior of a second container.

Preferably, step A comprises rotating a spiral assembly within said respective ingredient container.

Preferably, the blade element is cleaned within the container.

Preferably, the second container is a water container filled with water; and

wherein the method further comprises:

E1) spinning the blade element within the water container;

F1) optionally, disposing of the water and puree residues from the water container and filling said water container with fresh water.

Preferably, the puree is a hummus product.

Preferably, the second container is a housing container; and

wherein the method further comprises:

E2) squirting water on said blade element;

F2) optionally, disposing of the water and puree residues from the housing container.

Preferably, the respective one or more ingredient dosages is proportional to the spiral assembly rotating.

Preferably, the method further comprises a step prior to step A comprising:

transferring at least one of said one or more ingredient dosages from a respective cartridge into a corresponding container by rotating a spiral assembly within said respective cartridge.

Preferably, the method further comprises a step prior to step A comprising:

transferring at least one of said ingredient dosages from a respective cartridge into a corresponding container by the following steps:
providing the cartridge having a spinning bar and at least one receptacle having an opening and a hollow interior, each receptacle fixedly connected to one edge of the spinning bar;
providing the cartridge comprises a bottom valve having an opening; and
spinning the spinning bar until the opening faces and surrounds the valve opening; opening the valve (and typically after the content drops—closing the valve).

Embodiments of the present invention may comprise blade configurations as described herein having only sharp edges, having only blunt edges, having a blunt edge and a sharp edge, etc.

The present invention includes embodiments comprising particular features as described herein with additional features as described herein. For example, embodiments of the present invention may comprise one or more features selected from the group consisting of the blending vessel not comprising heating elements as described herein, ingredient containers with mixing elements as described herein, cartridges with mixing elements as described herein, the faucet as described herein, the spinnable blade element fixed to the end of an arm element as described herein, heating elements attached to the mixing elements as described herein, steam unit as described herein, air heating unit coupled to a heating chamber as described herein, air cooling unit coupled to a cooling chamber as described herein and vibrating surface as described herein.

The terms spinnable and rotatable are used herein interchangeably.

### BRIEF DESCRIPTION OF THE DRAWINGS:

The present invention is illustrated by way of example in the accompanying drawings, in which similar references consistently indicate similar elements and in which:

FIG. 1 illustrates an embodiment of the system of the present invention.

FIG. 2 illustrates another embodiment of the system of the present invention.

FIG. 3 illustrates an external housing embodiment of the system of the present invention.

FIGS. 4A-4D illustrate different positions of elements of a system according to an embodiment according to a certain aspect of the present invention.

FIGS. 5A-5B illustrate different positions of elements of a system according to an embodiment according to a certain aspect of the present invention.

FIGS. 6A-6Z illustrate various aspects of a system 301 according to an embodiment of the present invention.

FIGS. 7A-7E illustrate embodiments of the present invention vessel with a heating element attached thereon.

### DETAILED DESCRIPTION OF THE INVENTION:

The present invention relates to a system 1 for preparing, storing and dispensing fresh hummus and the like. The present invention comprises a blending vessel configured to receive cooked chickpeas, water (or e.g. a water mixture with salt), and possibly other food products. The present invention comprises a blade grinding unit configured to grind and blend the ingredients within the blending vessel, all into a common puree hummus product. The blending vessel may optionally comprise heating element attached thereon to maintain its content hot/warm enough such that it won't spoil, possibly for a long period of time. The system may comprise other means for heating the vessel (e.g. air heating unit as explained herein). The present invention enables for a gradual dispensing of the hummus product contained within the blending vessel, e.g. dispensing a dose whenever a system operator chooses to.

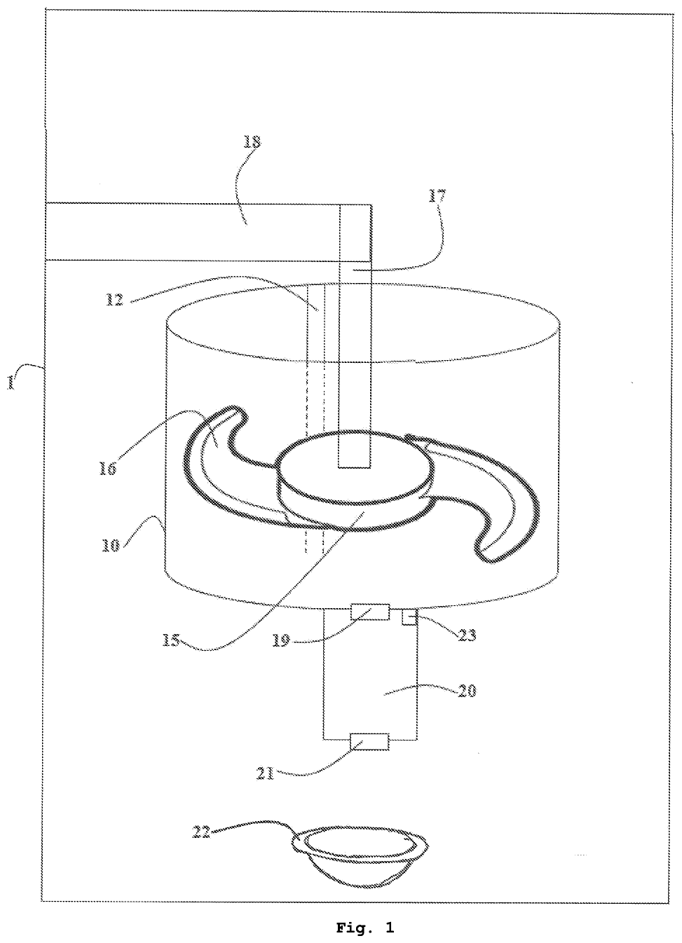

FIG. 1 shows an embodiment of the present invention. The present invention system 1 comprises a blending vessel 10 configured to receive cooked chickpeas, water (or e.g. a water mixture with salt), and possibly other food products, and grind and blend them all into a common puree hummus product. The operator chooses the quantity of the hummus product ingredients to be put in the blending vessel 10 e.g. stored ahead of time in precalculated bags (i.e. each ingredient precalculated in terms of weight or volume, etc.).

The present invention comprises a blade grinding unit (portions of which substantially function as a blade grinder) configured to chop the ingredients within the blending vessel while mixing them, by means of a high-speed spinning blade element 15 placed within the interior of blending vessel 10. The blade element 15 comprises at least one blade 16 (two blades 16 are shown in the embodiment of FIG. 1). The at least one blade 16 is placed substantially horizontally and spins horizontally around a central axis such that it can perform the grinding and mixing action of the ingredients within the blending vessel 10 so as to prepare the hummus product.

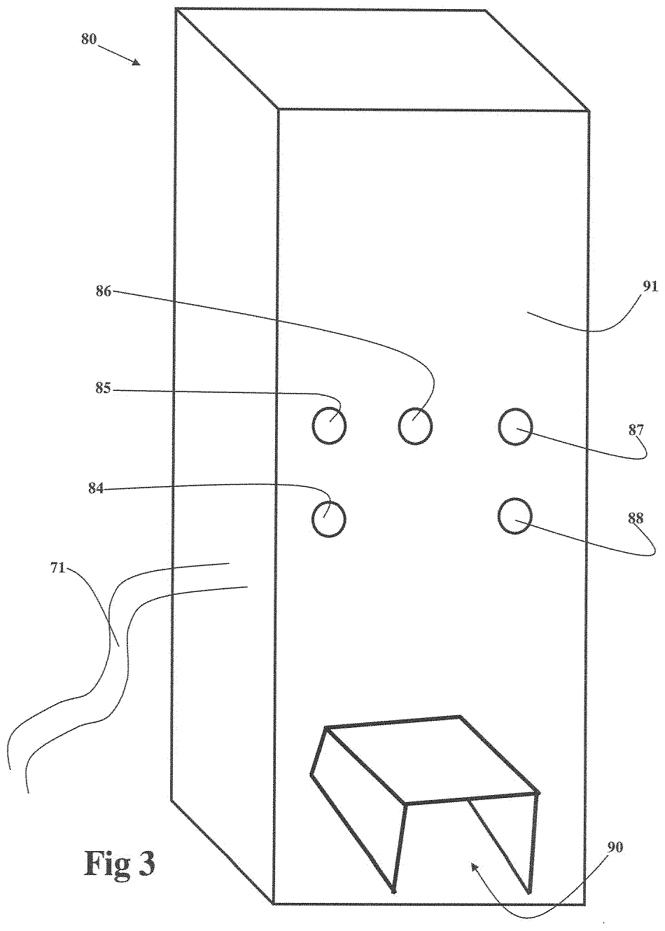

According to one embodiment, the blade element 15 is fixed to an upper arm element (fixed to a side wall of system 1, e.g. one of the side external walls of external housing 80 shown in FIG. 3) having a substantially vertical portion 17 and a substantially horizontal portion 18. The vertical portion (possibly being a shaft) comprises an electric motor (not shown) configured to rotate the blade element 15 (driving the rotation of the blade element 15) causing it to spin such that it can chop and mix the ingredients into the hummus product. According to one embodiment, the motor is configured to rotate a rotatable axle extending downward therefrom wherein the center of the blade element 15 is mounted on and fixed to the axle. Thus, the motor is configured to cause the axle (and thus the blade element 15) to spin. Optionally, motors that are used may be motors used in commercial blenders, food processors, various blade grinders and the like or similar motors.

Optionally, the horizontal portion 18 may be a telescopic arm configured to expand (i.e. lengthens) and contract (i.e. shortens) horizontally, wherein the expansion and contraction may be based on a hydraulic mechanism; and optionally, the vertical portion 17 may be a telescopic arm configured to expand and contract vertically, wherein the expansion and contraction may be based on a hydraulic mechanism.

According to another embodiment of the present invention, the blade element 15 is placed within the interior of the blending vessel 10 at a lower part thereof. The motor is placed at or near the bottom-center of the blending vessel 10 as in common blenders and food processors. In this embodiment the motor is configured to rotate a rotatable axle extending upwards therefrom (typically from beneath the blending vessel 10 and therethrough to its interior) wherein the center of the blade element 15 is mounted on and fixed to the axle portion within the interior of blending vessel 10. The motor is configured to cause the axle (and thus the blade element 15) to spin.

The blending vessel 10 may have the shape of any type of container which could enable the blade element 15 to blend. For example, the blending vessel 10 may have the shape of a bowl, a pot (a cylindrical shape), a square box, cuboid shape, etc.

The blending vessel 10 may comprise heating elements (not shown) attached thereon to maintain its content hot/warm enough such that it won't spoil, possibly for a long period of time. The heating elements may be attached to the bottom surface of the blending vessel 10 (typically on its external side) and/or to the side surface of the blending vessel 10 (typically on its external side). The heating elements are configured to heat, such that the interior hummus product is heated up to a certain degree that prevents formations of bacteria, in some cases for example 65 degrees Celsius, or 45 degrees Celsius. For this purpose, the blending vessel 10 preferably comprises material that enables heat transfer and thermal conductivity. Typically, the blending vessel 10 comprises metal (e.g. aluminum, stainless steel, etc.).

The heating elements may be in the form of a plurality of discrete elements attached having various shapes. Other heating elements used may have the form of ribbons or strips placed along the bottom surface of the blending vessel 10 and/or to the side surface(s) of the blending vessel 10 (e.g. in a spiral manner). For example, a heating element used has the form of a ribbon placed in a spiral manner along the side circumference of vessel 10.

In another embodiment the blending vessel 10 does not comprise heating elements attached thereon.

The rotation speed of the blade element 15 affects the texture, liquid content and fluidity of the hummus product. Therefore, the rotation speed is configured to be adapted to the required hummus product puree. In some embodiments the rotation speed may be variable such that it is adapted to the desire of the system operator. In addition, the sharpness of the blades 16, the heat of the cooked chickpeas and their softness also affect the texture, liquid content and fluidity of the hummus product and therefore may be adjusted/chosen for the required hummus product.

The bottom of blending vessel 10 comprises a valve 19 such that when in an open state the hummus product within the blending vessel 10 may be discharged therethrough. The valve 19 may be in the center of the bottom of blending vessel 10 or at another location (e.g. when the blade element 15 and accompanying motor are placed at the center).

In some embodiments the hummus product may be discharged through valve 19 directly to a dish (this embodiment not shown) to be served to a buyer. The system is arranged so that, in use, the hummus product is discharged from the blending vessel 10 under the influence of gravity.

According to another embodiment of the present invention, the bottom of blending vessel 10 comprises a faucet (not shown) such that when in an open state the hummus product within the blending vessel 10 may be discharged therethrough. The faucet enables discharging a desired amount of the hummus product each time used. The faucet may be a mechanical faucet or an electric faucet. The faucet may have a suction feature configured to suck the hummus product from the blending vessel 10. In case of the electric faucet, according to one embodiment, the electric faucet may discharge a predefined amount of the hummus product (e.g. a predefined volume that it measures while discharging and ends the discharging when the volume is reached (this measuring feature is known and used in existing faucets)). Typically, the discharged volume corresponds to the required dosage weight to being sold—e.g. 250 grams.

According to an embodiment of the present invention the faucet as explained herein may be placed such that it projects from a side wall of system 1 (e.g. from the front wall 91, as shown in FIG. 3). In this case the faucet is coupled to a bottom discharge opening of the blending vessel 10 by means of a transport path (e.g. a tubular element, a pipe, a tube, etc.). Optionally the discharge opening is placed at a location (preferably low location near the bottom) of the side of the blending vessel. Alternatively, the present invention may comprise a valve (instead of a faucet) coupled to a bottom discharge opening of the blending vessel 10 by means of a transport path as explained hereinabove, mutatis mutandis.

According to an embodiment of the present invention the blending vessel 10 comprises a level sensor 12 such that the amount of the hummus product discharged is a predefined dosage defined by the difference of the level of the top surface of the hummus product. When the level sensor detects that the amount of the hummus product has lessened (i.e. the top surface of the hummus product has gone down to a certain level) the valve is closed. Also, when the top surface of the hummus product is almost at the lower end of the blending vessel 10, an alert may be triggered (e.g. a red lightbulb might light up indicating this).

According to a preferred embodiment of the present invention a cup element 20 is attached to the external surface of the blending vessel 10. The cup element has the volume of a desired dosage of the hummus product to be sold. The cup element 20 comprises an open top portion which is attached to the external side of the lower surface (bottom surface) of the blending vessel 10 such that the cup 20 (open top portion) surrounds valve 19 and its interior is beneath valve 19 (such that the hummus product may be discharged into the cup 20 interior). When valve 19 opens, the hummus product is discharged therethrough and fills cup element 20. The system is arranged so that, in use, the hummus product is discharged from the blending vessel 10 to the cup element 20 under the influence of gravity.

The bottom surface of cup 20 comprises a valve 21 such that when in an open state the hummus product within the cup element 20 may be discharged therethrough. After the cup 20 is fully filled with the hummus product, valve 19 closes and thereafter valve 21 opens such that the hummus product within cup element 20 is fully discharged (and thus dispensed) into a serving dish 22 (e.g. in the form of a bowl) placed at a spatial area beneath valve 21. Typically, the volume of dish 22 is slightly larger than the volume of cup 20 such that the hummus product does not overspill from its sides. Optionally the cup 20 comprises a level sensor 23 such that when the cup 20 is filled to the top (and detected by level sensor 23), the valve 23 closes and valve 21 opens.

The bottom cup 20 may have a volume corresponding to the weight of a dosage of the hummus product sold (when the hummus product has the desired fluidity). An example of a hummus product dosage sold is 250 grams.

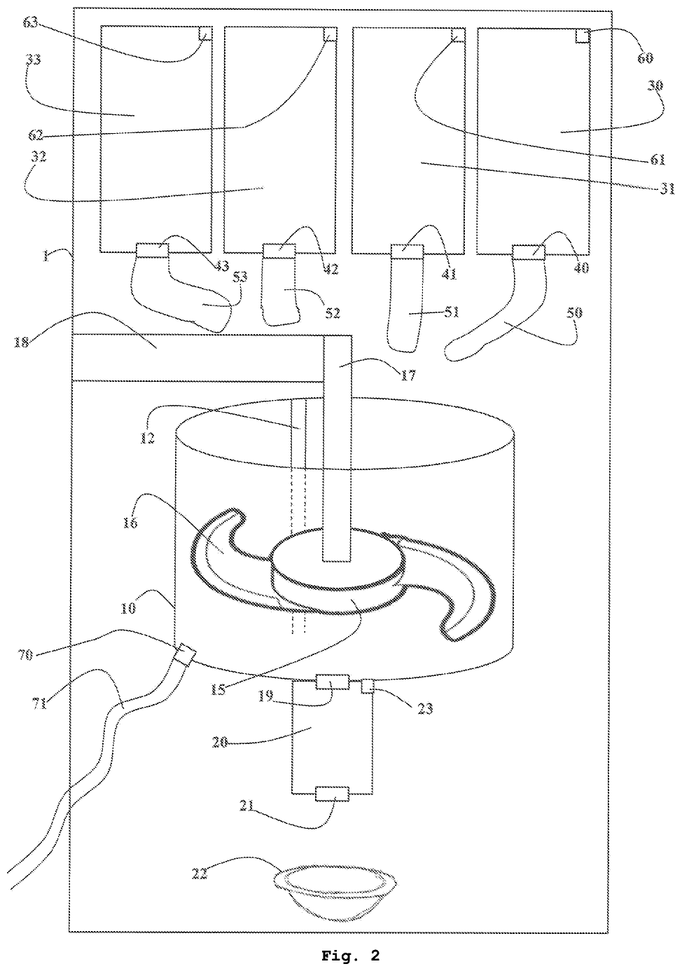

According to a preferred embodiment of the present invention, the system 1 comprises one or more ingredient containers placed above (at a higher height in relation to) the blending vessel 10, as shown in FIG. 2. The ingredient containers hold and store the ingredients and dispense the required amount of ingredients for a single blending cycle (the blending cycle comprises blending given ingredients inserted into the vessel for producing a hummus product and dispensing said hummus product until the next blending cycle where the next group of ingredients are inserted into the blending vessel 10). FIG. 2 shows an embodiment with a chickpeas ingredient container 30 (possibly with water or without water, e.g. the water that the chickpeas were cooked in), a tahini ingredient container 31 (preferably for raw tahini), a water-salt mixture (or water alone) ingredient container 32 (optionally containing additional spices or seasonings) and an olive oil ingredient container 33. These containers may, for example, have the form of a cuboid. The ingredient containers have a top opening so that they will be initially filled (by the operator) with the desired respective ingredient. The containers may be of various shapes and each have a bottom surface.

Each of the ingredient containers 30, 31, 32 and 33 bottom surfaces comprise a corresponding valve 40, 41, 42 and 43 such that when in an open state the ingredients within the respective ingredient containers 30, 31, 32 and 33 may be discharged therethrough. Respective transport paths 50, 51, 52 and 53 extend from the respective valves 40, 41, 42 and 43 downwards (or diagonally downwards) to a spatial area above the blending vessel 10 (such that ingredients passing therethrough will fall into blending vessel 10 under the influence of gravity) or within the blending vessel 10 (i.e. such that they are in communication with inner cavity of blending vessel 10). In this manner the respective ingredients discharged from the respective containers 30, 31, 32 and 33 and pass via the respective transport paths 50, 51, 52 and 53 to the area above or within blending vessel 10 thereafter fall into the blending vessel 10. The ingredients discharged from the containers end up within the blending vessel 10 under the influence of gravity.

In some alternative embodiments the ingredient containers bottom surfaces comprise openings where the ingredients are discharged therethrough, and wherein respective valves are placed within the respective transport paths extending from the bottom openings to the spatial area within or above the blending vessel 10.

The transport paths may be in the form of tubular elements, e.g. pipes, tubes, tapering pipes.

Each of the ingredient containers 30, 31, 32 and 33 comprises a respective level sensor 60, 61, 62 and 63. The level sensors 60, 61, 62 and 63 are configured to detect the level of the ingredients within the respective containers such that the amount of the respective ingredient discharged for each blending cycle is a predefined dosage defined by the difference of the level of the respective ingredient within its respective container 30, 31, 32 and 33.

According to one embodiment, the chickpeas container 30 is configured to receive cooked chickpeas and heat them up and maintain them hot such that they do not spoil. In this embodiment the chickpeas container 30 comprises heating elements (not shown) attached thereon to maintain its content hot/warm enough such that it won't spoil, possibly for a long period of time. The heating elements may be attached to the bottom surface of the chickpeas container 30 (typically on its external side) and/or to the side surface of the chickpeas container 30 (typically on its external side). The heating elements are configured to heat, such that the interior cooked chickpeas are heated up to a certain degree that prevents formations of bacteria coliforms, salmonella, etc., in some cases for example 65 degrees Celsius, or 45 degrees Celsius. For this purpose, the chickpeas container 30 preferably comprises material that enables heat transfer and thermal conductivity. Typically, the chickpeas container 30 comprises metal (e.g. aluminum, stainless steel, etc.)

The heating elements may be in the form of a plurality of discrete elements attached having various shapes. Other heating elements used may have the form of ribbons or strips placed along the bottom surface of the blending chickpeas container 30 and/or to the side surface of the chickpeas container 30 (e.g. in a spiral manner). For example, a heating element used has the form of a ribbon placed in a spiral manner along the side circumference of chickpeas container 30.

According to another preferred embodiment of the present invention the chickpeas container 30 comprises heating elements such that they are used to cook raw chickpeas in water placed within chickpeas container 30. In this case the heating elements are configured to heat the chickpeas container 30 such that its interior reaches a high temperature, for example 93 degrees Celsius. The power needed for this may be for example 3.4 kW. Optionally, after the chickpeas are cooked the heat may be maintained such that it doesn't spoil, as explained hereinabove (the heating elements function from the cooking mode to the maintaining mode). A preferred manner of the cooking of the chickpeas which may contribute to a substantial removal of gas from the hummus product being prepared is cooking at around 93 degrees Celsius for about an hour and then cooking at around 60 degrees Celsius for about half an hour. Similar cooking methods for cooking chickpeas may be applied also in other embodiments prior to placing the chickpeas into the container 30. The heating elements may be attached to container 30 (e.g. on the exterior surface, or within the container 30). According to an embodiment of the present invention, the container 30 with the “cooking” heating elements (configured to cook the raw chickpeas) is a type of pressure cooker, configured to cook the chickpeas at high pressure employing water or a water-based cooking liquid, in the pressure cooker (which is a sealed vessel).

Other embodiments of the present invention may comprise additional or alternative or less ingredient containers. For example, some embodiments may comprise garlic containers, lemon juice containers, etc.

According to an embodiment of the present invention, the system 1 comprises a water hose (not shown) comprising an end piece comprising a plurality of nozzles, some of which face (i.e. are configured to squirt on) one or more of the following: the transport paths 50, 51, 52 and 53, the blade element 15, the inner surface of the blending vessel 10 and the upper arm element (17 and 18). Typically, the nozzles are divided into groups wherein each respective group faces a corresponding element (or a portion of a corresponding element) of the following elements: the transport paths 50, 51, 52 and 53, the blade element 15, the inner surface of the blending vessel 10 and the upper arm element (17 and 18). The end piece is typically placed above the blending vessel 10 and beneath the transport paths 50, 51, 52 and 53. This washing feature is configured to clean these elements. The bottom of blending vessel 10 comprises a valve 70 such that when in an open state the water with the residues (ending up within the blending vessel 10) may be discharged therethrough to a drainage hose 71 (extending from said valve 70) leading to drainage (e.g. an eternal drainage port) where it is disposed of. The valve 70 may be at the side of the bottom surface of vessel 10 or at another location. The water hose is coupled to an external water source (e.g. external water faucet). The water hose may be turned on and off mechanically or optionally electrically.

According to an embodiment of the present invention, a partition surface (not shown) may be provided beneath the blending vessel 10 separating between:
A) the elements including blending vessel 10, blending element 15 and the arm to which it is attached to, the transport paths, and ingredient containers; and between
B) the cup and the dish 22.

The partition surface may hold the dirty water with the residues after a cleansing cycle of the water hose. The partition surface comprises a valve such that when in an open state the water with the residues (ending up externally to the blending vessel 10 and accumulated on the partition surface) may be discharged therethrough to a drainage hose (not shown) leading to drainage (e.g. an eternal drainage port) where it is disposed of. The valve alternatively, may be at a side surface of system 1.

According to any of these washing embodiments, the present invention actually comprises and functions as a “dishwasher” unit, configured to cleanse dirty elements involved with the hummus product preparation.

According to one embodiment of the present invention (where the chickpeas container 30 is configured to cook the chickpeas) a surrounding flange (not shown) is disposed around the chickpeas container 30 (at its top edge or somewhere around its side surface) such that the surrounding flange is configured to receive overflow boiling water and/or overflowing foam during the cooking process. The flange comprises a drainage opening coupled to drainage hose 71 (e.g. by a hose).

According to an embodiment of the present invention (typically for the embodiment where the chickpeas are cooked in the container but not only) the transport path 50 comprises small slits or holes for draining the water from the chickpeas container 30 when a dosage of chickpeas are transferred to the blending vessel 10 for a blending cycle. Optionally the drained water is collected by a hose (not shown) having a hose opening beneath the slits. This hose is coupled to drainage hose 71.

According to an embodiment of the present invention the bottom surface of chickpeas container 30 comprises a second valve (not shown) such that when in an open state a dose of cooked chickpeas within container 30 may be discharged therethrough to a second transport path (not shown) leading to the spatial area above dish 22, such said dose of cooked chickpeas may be added to the hummus product in the dish that is sold. In this embodiment the second transport path comprises small slits or holes for draining the water from the chickpeas container 30. Optionally the drained water is collected by a hose (not shown) having a hose opening beneath the slits. This hose is coupled to drainage hose 71. The chickpeas discharged from chickpeas container 30 end up within the dish 22 under the influence of gravity.

According to an embodiment of the present invention the bottom surface of olive oil container 33 comprises a second valve (not shown) such that when in an open state a dose of olive oil within container 33 may be discharged therethrough to a second transport path (not shown) leading to the spatial area above dish 22, such said dose of olive oil may be added to the hummus product in the dish that is sold. The olive oil discharged from container 33 ends up within the dish 22 under the influence of gravity. Similarly, according to other embodiments of the present invention, additional/alternative ingredient containers may be filled with mushrooms, vegetarian meat, shawarma, etc., (configured to be discharged via appropriate transport paths that lead to the spatial area above dish 22) ending up within the dish 22 under the influence of gravity. Optionally, these ingredients may lead to the spatial area above a side dish (not shown) near dish 22 leading to the interior of said side dish mutatis mutandis.

System 1 comprises a control unit (not shown) comprising a processor. The control unit is electrically coupled to level sensors 60, 61, 62, 63, 12, 23, the blade element 15 motor (within element 17), the valves 40, 41, 42, 43, 19, 21, 70, the second valves of containers 30 and 33, the heating elements attached to blending vessel 10, the heating elements attached to container 30 (either for cooking or maintaining heat), a valve for turning the water hose on and off, an electric faucet, and all other electric units in the system 1. System 1 comprises a power unit (not shown) electrically coupled to all of the aforementioned electric units in the system 1 and configured to power them. Typically, the power unit is electrically coupled to an external power source (e.g. external power socket). The control unit is configured to receive level indications from all of the aforementioned level sensors. The control unit is configured to activate all of the valves (open and close them), the blade element 15, the motor (within element 17), the heating elements (as defined herein), the electric faucet and the other electric units defined herein.

The system 1 may function in various manners. For example, the chickpeas may be cooked in container 30 where the control unit activates the cooking heating elements of container 30. After a predefined time, the control unit changes the function of the heating elements on container 30 from cooking to maintaining heat. When a first blending cycle of hummus is desired, the valve 40 opens until a dosage fitted for the blending cycle is transferred thereto. When the level sensor 60 indicates that an appropriate dosage (corresponding to the respective level difference of the cooked chickpeas within container 30) for a blending cycle has exited the container then the control unit (receiving this data) closes the valve 40. The same thing is carried out for containers 31, 32, 33, with valves 41, 42, 43, mutatis mutandis. Then, the control unit activates the blender 15 motor for a predefined period of time. Then, each time a dosage of the hummus product being sold is required the valve 19 is opened until the level sensor 23 detects that the amount in the cup 20 is full. Then valve 19 closes and valve 21 opens. Alternatively valve 19 is open for a predetermined time such that the hummus product will typically fully fill the cup 20, and then valve 19 closes and valve 21 opens. Optionally, each time a dosage of the hummus product being sold is required the operator may press on a button (85 in FIG. 3) or other switch item (coupled to the control unit and the power unit) and the valve 19 is opened, etc., as explained hereinabove.

According to an embodiment of the present invention if the hummus product in vessel 10 is not dispensed within a predetermined period of time (e.g. 20 minutes) the control unit activates the blade element 15 to spin for a predetermined period of time (e.g. 30 seconds). This contributes to prevent drying of the hummus product. In another embodiment, the blade element 15 may spin continuously (at a predetermined speed).

When the hummus product reaches a low point in blending vessel 10, level sensor 12 indicates this to the control unit and an alert lightbulb (also coupled to the control unit and the power unit) may be activated indicating this (for the operator to initiate a second (consecutive) blending cycle).

Optionally, each time a new (consecutive) blending cycle is desired (for example when the alert lightbulb is activated), the operator may press on a button (86 in FIG. 3) or other switch item (coupled to the control unit and the power unit) and the valves 40, 41, 42, and 43, open for the ingredients (for an amount of a single blending cycle) to be transferred to the blending vessel 10, etc., as explained hereinabove.

Alternatively, when the hummus product reaches a low point in blending vessel 10, level sensor 12 indicates this to the control unit which opens valves 40, 41, 42 and 43 for the next blending cycle (opened until the respective level sensors indicate that a respective blending cycle dosage amount has exited the respective ingredient container). According to this embodiment the system can fully function non-stop (e.g. all day long) possibly with the operator only refilling the respective ingredients container when needed.

According to an embodiment of the present invention, temperature sensors (also coupled to the control unit and the power unit) may be attached to the interior of the container 30 and the blending vessel 10 in order to control the heating elements to maintain the heat at a predefined temperature, and in a cost efficient manner (e.g. turning off some of the heating elements if the temperature exceeds a certain temperature and turning them on if the temperature is lower than a predefined temperature).

According to an embodiment of the present invention the system 1 comprises a cuboid shaped external housing 80 typically having a topping cover and side wall surfaces, housing the elements of system 1, i.e. the ingredient containers, the blending unit, the blending vessel, the cup element, etc. The external housing walls may have operation buttons (all coupled to the control unit and the power unit). Operation buttons 85 and 86 are explained hereinabove. Operation button 87 activates the second valve in container 30 delivering a dosage of cooked chickpeas to dish 22. Operation button 88 activates the second valve in container 33 delivering a dosage of olive oil to dish 22. Operation button 84 opens and closes the drainage valve 70 during the washing procedure.

Optionally, the system 1 external housing 80 may be accessible to buyers who whish to buy a hot hummus product. A payment device such as a coin machine or credit card unit (as known in the art) is integrated with the present invention to enable a buyer to purchase a dish of hot hummus. The payment device may be connected to the control unit such that a corresponding operational function (e.g. dispensing a puree dose) may be carried out after payment. For example, buttons 85, 87 and 88 may be accessible (i.e. functional) to the buyers after payment is made. Other embodiments may include dispensing the puree as explained herein (according to any one of the aspects/embodiments explained herein) after payment is made to the payment device. The external housing 80 may comprise an opening leading to a cavity (chamber) 90 for placing the dish 22 therein such that it is in place to receive the hummus product, i.e. beneath valve 21 (not shown in FIG. 3). Optionally, the system 1 comprises a cartridge (not shown) filled with a stack of disposable dishes 22. According to this embodiment, when a buyer presses button 85, one of the dishes 22 in the stack is placed in place to receive the hummus product within cavity 90. Optionally, a front side 91 of external housing 80 is transparent so that a buyer may be able to view the hummus preparation and dispensing procedures.

Optionally the control unit comprises a memory and a numerator/counter. The control unit may thus count the number of times a dosage of the hummus product is dispensed (e.g. the number of times per day) until the numerator is reset. Optionally, a barcode and/or selling date and/or expiring date may be stamped on dish 22 (or stamped on a sticker placed thereon) when a dosage is dispensed. The present invention may comprise stamping devices as known in the art for this feature. Optionally, the control unit comprises a transmitter for transmitting the numerator value when required or every predetermined period of time (e.g. transmitting to a cellular phone, etc.).

All of the elements at their corresponding locations may be fixed, e.g. to a corresponding location within housing 80. Typically, all of the main elements e.g. ingredient containers, blending vessel 10, blade element 15, transport paths, cup 20, may be disconnected, washed and reconnected again.

The valves as explained herein may be various types of valves as known in the art. For example, the valves at the surfaces may be trap door valves, sliding door valves rotating door valves, etc.

The level sensors as explained herein may be various types of level sensors as known in the art, e.g. ultrasonic level transmitters, radar or microwave level transmitters, magnetic float level transmitters, level sensors that sense each time the top surface of the contained material reaches a line (as known in the art), etc.

According to one embodiment of the present invention, the control unit may open the water hose valve and drainage valve if the hummus product within blending vessel 10 stands without motion for over a predetermined period of time.

According to an embodiment of the present invention, the system for preparing and dispensing a puree comprises a horizontal conveyor (not shown). The horizontal conveyor may extend e.g. from within cavity 90 outwards towards the user. The horizontal conveyor may be fixed to the bottom portion of cavity 90. A manner of function may be such that the user places a serving dish on the outer side of the conveyor at a dedicated place. The user may operate the system by pressing a dedicated button (coupled to the control unit) that activates the conveyor (coupled to the control unit, power source etc., e.g. a conveyor motor coupled to the control unit and power source) and the conveyor conveys the dish into cavity 90, ready to receive the hummus product. Then the hummus is dispensed as explained herein (according to any one of the embodiments explained herein) and the conveyor then returns the serving dish (filled with the hummus product) to the aforementioned dedicated place. Optionally the system further comprises a sliding door (optionally transparent) at the opening of cavity 90. The sliding door (coupled to the control unit, power source etc., e.g. having a dedicated motor coupled to the control unit and power source) opens prior to the serving dish entering the cavity 90 and closes thereafter. After the serving dish is filled, sliding door opens prior to the serving dish exiting the cavity 90 and closes thereafter. This manner ensures a safe use of the system preventing the user from potentially getting hurt. The conveyor may be any type of appropriate conveyor, as well known in the art. The sliding door mechanism may function according to any of the mechanisms known in the art.

The present invention enables to provide fresh hummus without any preservatives, food supplements or additives. The present invention enables to provide fresh hummus based only on fresh ingredients.

The present invention relates to a method for preparing and dispensing a puree. Some of the terms used in relation to the method may be understood at different portions in the description of the corresponding system herein.

The method comprises the following steps:

A) placing one or more ingredient dosages into a vessel to be blended in a blending cycle;

B) blending the one or more ingredients inside the vessel into a puree;

C) periodically dispensing a dosage of the puree content of step B;

D) periodically placing a consecutive group of one or more ingredient dosages into the vessel to be blended in a consecutive blending cycle and blending the consecutive group of one or more ingredient dosages inside the vessel into a puree, and returning to step C; wherein said method does not comprise heating the vessel. Other embodiments comprise heating the vessel as explained herein. In some cases, dispensing a dosage of the puree content may be carried out before or during the heating of the vessel stage.

Preferably, dispensing a dosage of puree from the vessel may be carried out simultaneously during or after either one of steps A and B.

Preferably, step D is carried out when either of the following conditions are met:
a) when the puree content of step B is all dispensed;
b) when the puree content of step B is almost all dispensed.

Preferably, step A comprises transferring each of the one or more ingredient dosages from a corresponding container to the vessel.

Preferably, the puree in steps B and D are hummus products.

The present invention may not only be used with hummus. Several other Legumes or other products used for preparing mashes, purees, spreads, pastes, pulps, sauces, dips, smoothies, soups (e.g. thick soups) and the like, may be used with the present invention as described herein.

The method may comprise placing the dish on the conveyor, etc., as described herein with respect to the system.

The method step of placing one or more ingredient dosages into the vessel may comprise transferring said one or more ingredient dosages, each from a respective ingredient container, wherein said transferring comprises rotating a respective spiral assembly (e.g. elements 500, 600, as explained herein) within a corresponding ingredient container.

Preferably, the amount of a respective ingredient dosage transferred from the one or more ingredient dosages is proportional to the rotating of the respective spiral assembly.

Preferably, the method further comprises a step prior to step A comprising:

transferring at least one of said ingredient dosages from a respective cartridge (e.g. cartridges 730, 731 explained herein) into a corresponding container by rotating a spiral assembly within said respective cartridge.

Preferably, the method further comprising a step prior to step A comprising:

transferring at least one of said ingredient dosages from a respective cartridge (730′ as explained herein) into a corresponding container by the following steps:
providing the cartridge having a spinning bar and at least one receptacle having an opening and a hollow interior, each receptacle fixedly connected to one edge of the spinning bar;
providing the cartridge comprises a bottom valve having an opening;
spinning the spinning bar until the opening faces and surrounds the valve opening; opening the valve.

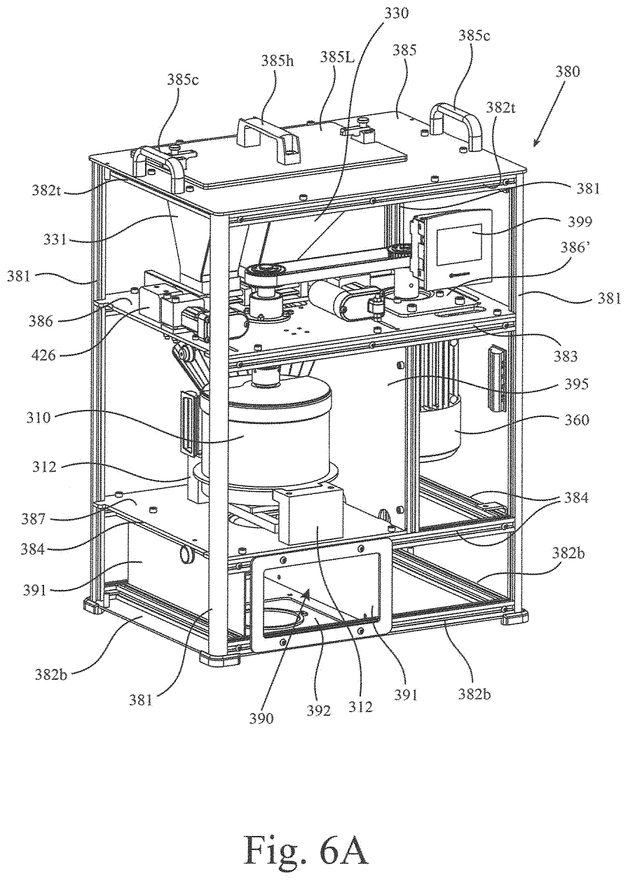

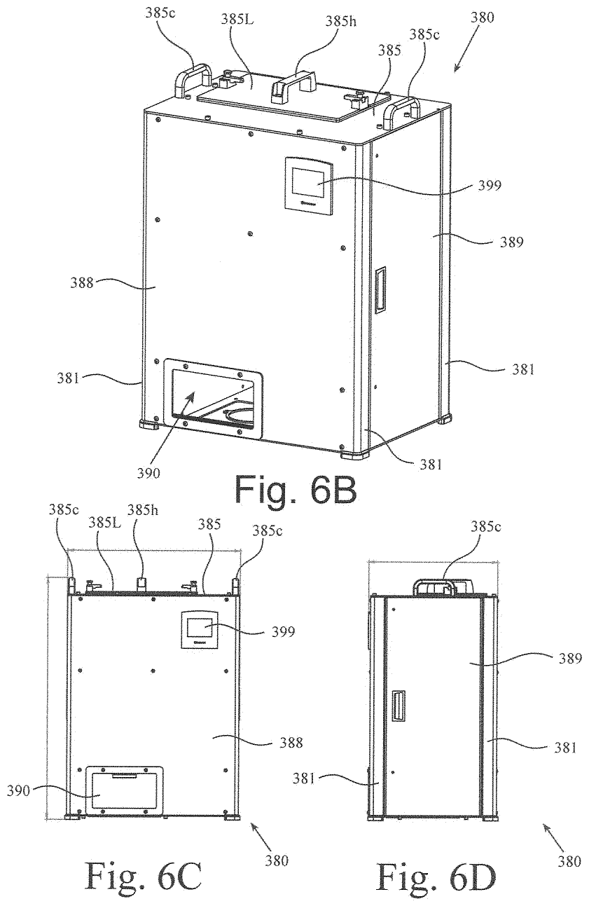

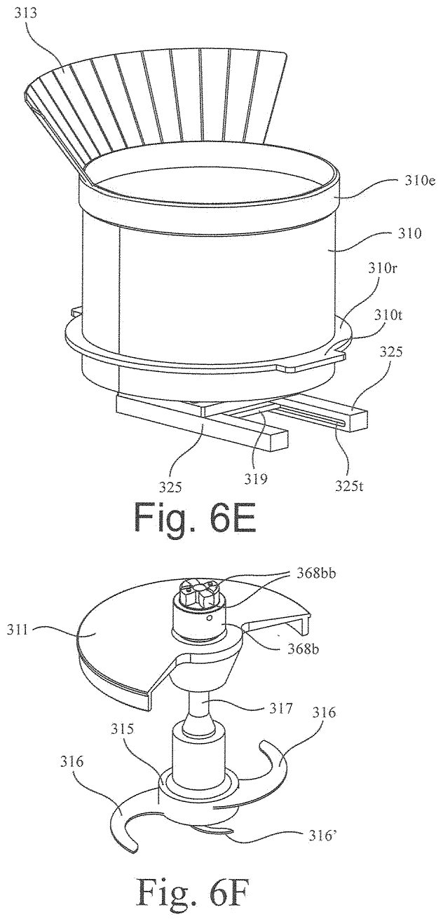

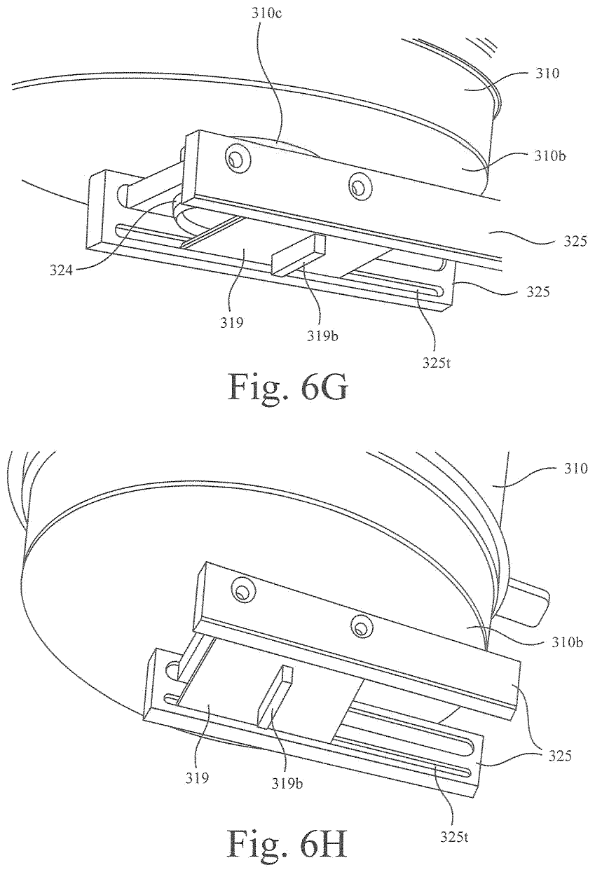

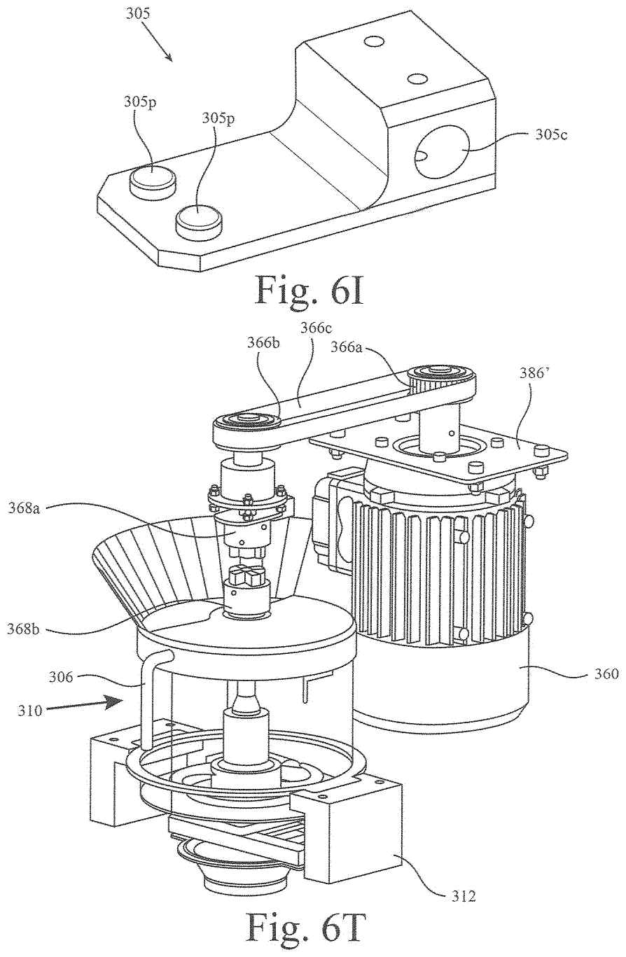

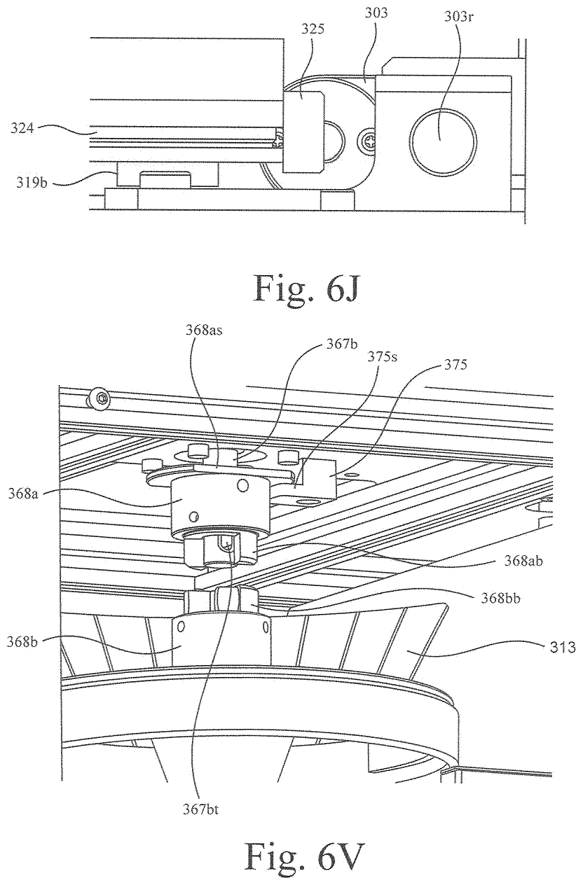

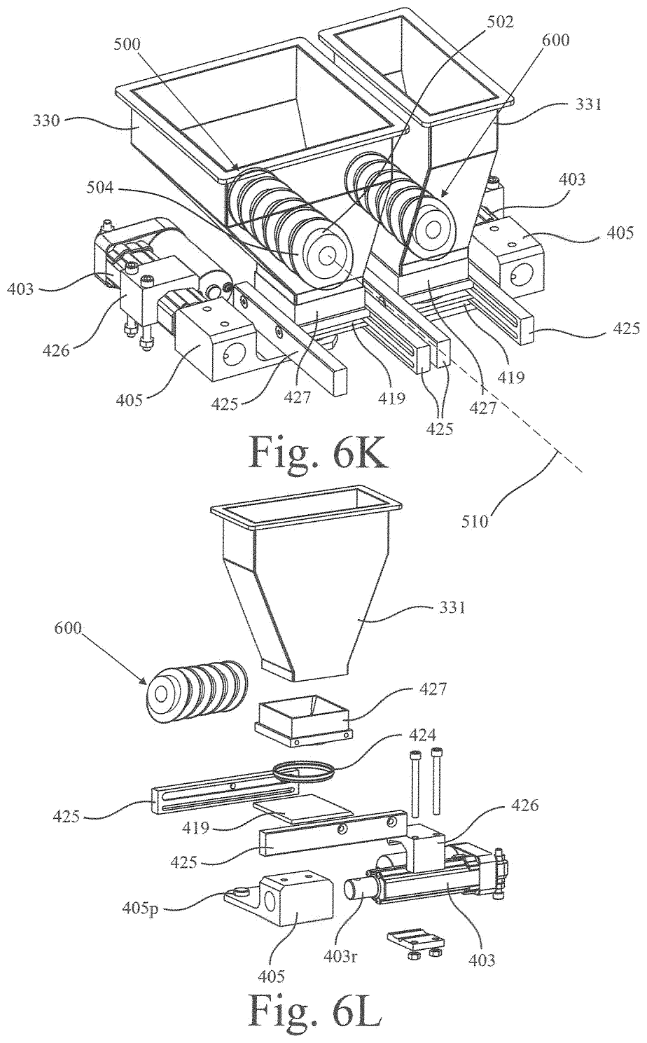

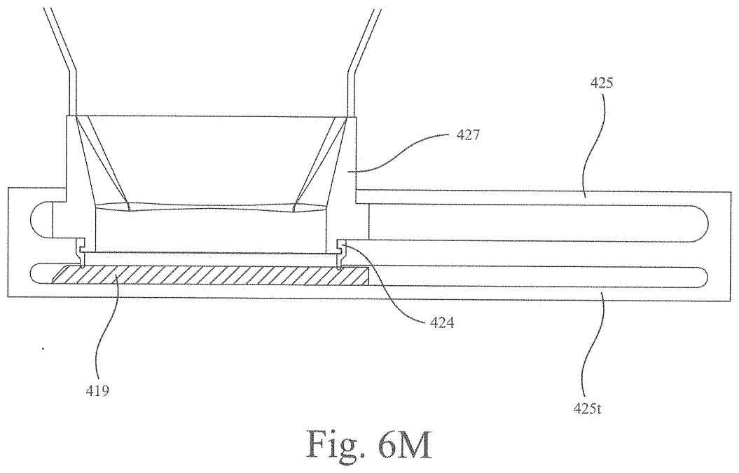

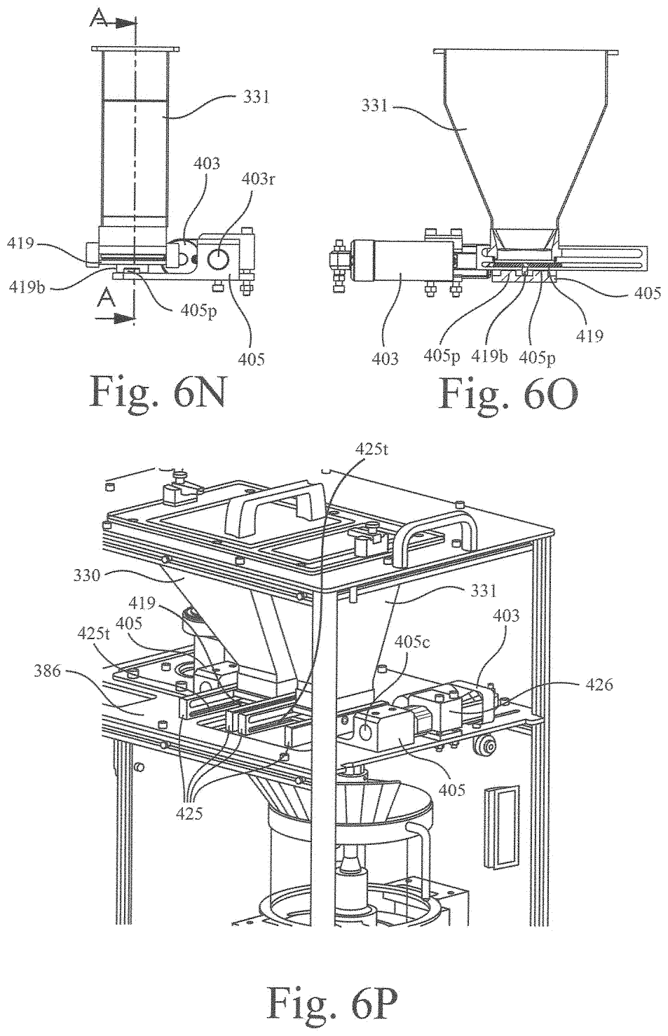

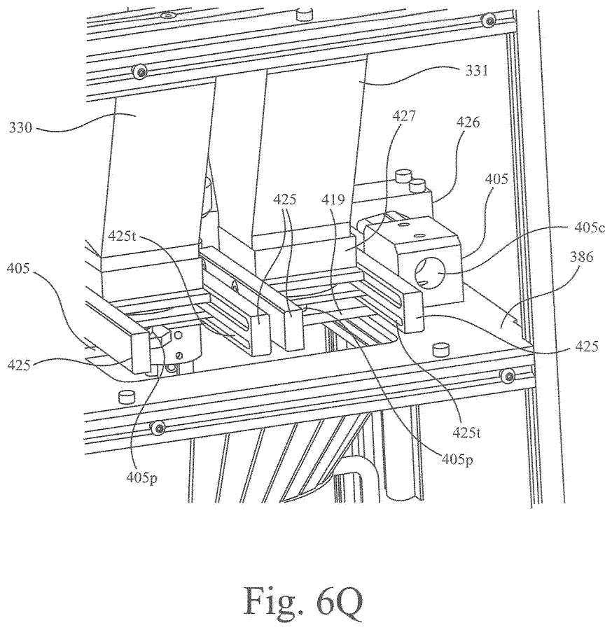

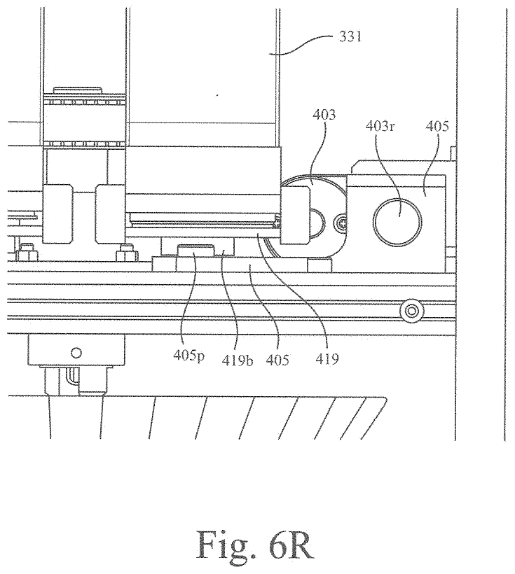

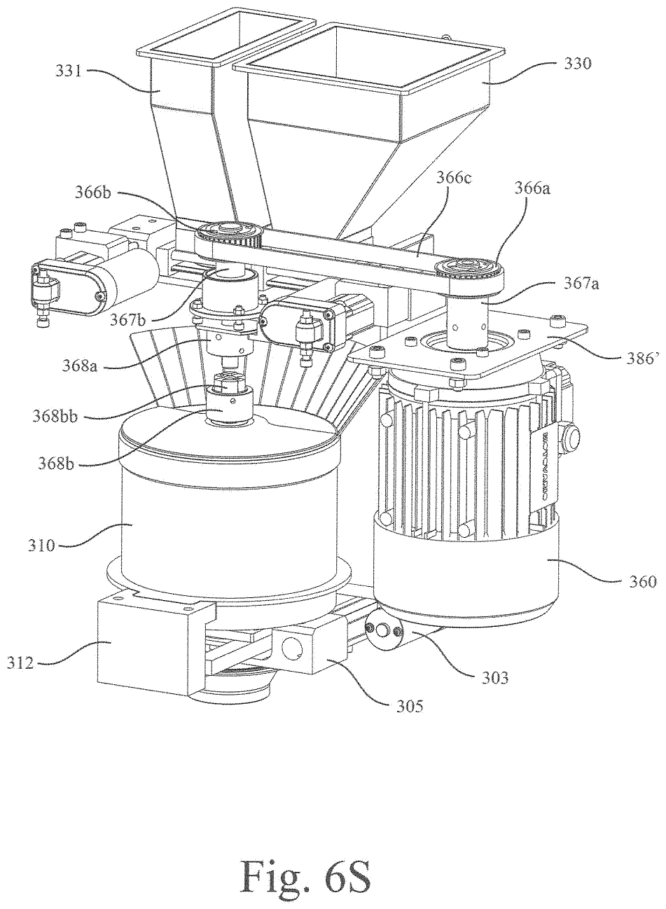

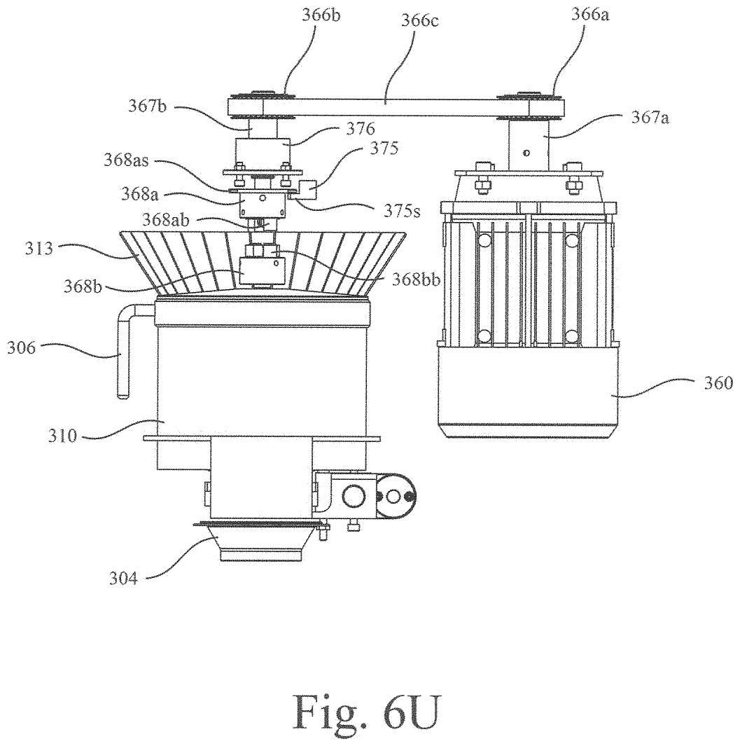

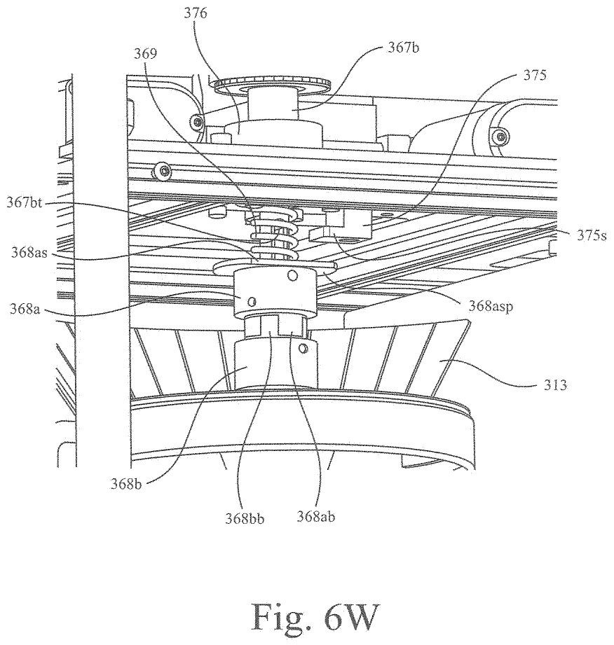

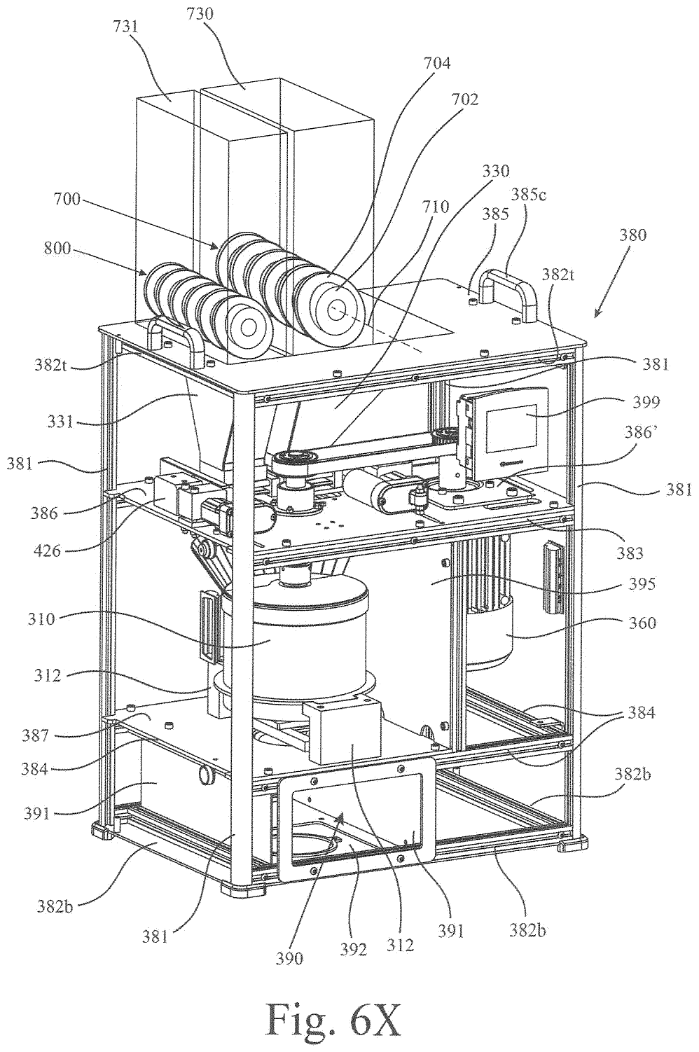

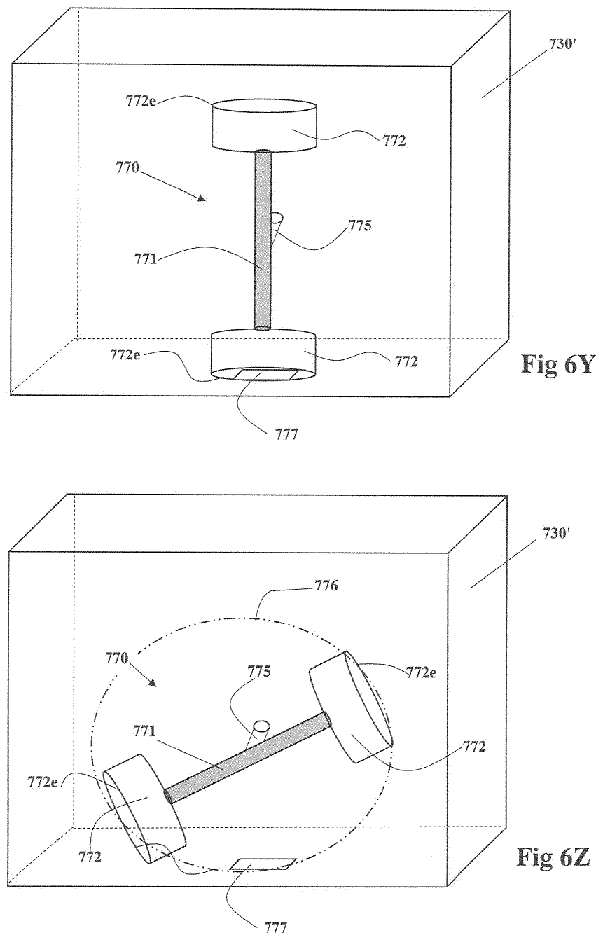

FIGS. 6A-6W show a preferred embodiment of the present invention relating to system 301 of the present invention. In general, system 301 is similar to system 1 unless specifically indicated otherwise. In some cases specific elements from system 1 are explained in more detail. The explanations of the general concept or the function of some elements of system 301 will be brief (or not at all) as they have been explained in detail herein. In other cases, specific elements explained in relation to system 1 will not be mentioned at all in relation to system 301 as it is clear that they may apply to system 301 as well, mutatis mutandis.

FIG. 6A shows an embodiment of the present invention. The present invention system 301 comprises a blending vessel 310 configured to receive e.g. cooked chickpeas (and possibly water, salt, etc.) from a first ingredient container 330, and e.g. tahini from a second ingredient container 331 and grind and blend them all (by blending means) into a common puree hummus product. The hummus product is thereafter dispensed. In some embodiments, the blending vessel 310 does not have an attached heating unit and does not comprise heating elements whatsoever attached thereto. In other embodiments, the blending vessel 310 has a heating unit 302 (comprising heating elements) attached thereto. System 301 further comprises a motor 360 for driving the blending means.

The system 301 comprises an external housing 380 having the form of a cuboid. Housing 380 comprises four vertical posts 381 at the side edges of the cuboid, four horizontal bars 382t at the top of the cuboid and four horizontal bars 382b at the bottom of the cuboid, thus forming 12 edges of the cuboid. The housing 380 further comprises four additional horizontal bars 383 forming a rectangle at a lower level from the top horizontal bars 382 (and parallel thereto) and four additional horizontal bars 384 forming a rectangle at a lower level from the additional horizontal bars 383 (and parallel thereto). The housing 380 comprises a top (first) horizontal surface 385 placed on and attached to the top horizontal bars 382t. The top horizontal surface 385 comprises an ingredient inserting opening above the containers 330 and 331, and a lid 385L for opening and closing said ingredient inserting opening. When in an open state, respective ingredients may be inserted (by a system user) into the respective containers 330 and 331. Lid 385L preferably comprises a handle 385h attached thereto, for the user to easily grasp the lid 385L for the opening and closing.

The housing 380 comprises a second horizontal (bearing) surface 386 placed on and attached to the horizontal bars 383, for bearing the containers 330 and 331. Surface 386 comprises an opening underneath the outputs of containers 330 and 331 so that the ingredients may fall into the vessel 310 (when the outputs are open). The housing 380 comprises a third horizontal (bearing) surface 387 placed on and attached to the horizontal bars 384, for bearing the vessel 310 (or the elements holding the vessel 310). The housing 380 comprises a hummus product receiving chamber (cavity) 390 for receiving the hummus product from above. The receiving chamber 390 comprises side walls 391, a bottom surface 392 and a top surface (possibly part of surface 387). Surface 387 comprises an opening underneath the output of vessel 310 so that the puree hummus product may fall onto a dish placed in the receiving chamber 390 when the vessel 310 bottom output opening is open (as the vessel 310 output opening is placed above chamber 390). The external housing 380 further comprises a vertical wall 395 placed between horizontal surfaces 386 and 387. The motor may be mounted on vertical wall 395 and attached thereto. Alternatively, the motor may be mounted on a top surface 386′ (which is attached to surface 386), thus hanging therefrom. A control unit 399 that is connected to several elements as explained herein (e.g. motor 360, piston units, heating elements, sensors) and that is configured to control their operation, is also shown.

FIG. 6A shows the external housing 380 without its side walls. FIG. 6B shows a perspective view of the external housing 380 with a front surface wall 388 and a side surface wall 389. The system 301 may comprise carrying handles 385c at its sides for carrying system 301. FIG. 6C shows a front view of external housing 380. FIG. 6D shows a side view of external housing 380. The external housing 380 height may be for example, between 650 and 850 mm. The external housing 380 length may be for example, between 400 and 650 mm. The external housing 380 width may be for example, between 300 and 500 mm. An example size (shown in the figures) of external housing 380—a height of 731 mm, a length of 525 mm and width of 388.5 mm. The sizes of the elements therein may be accordingly (e.g. in same ratio as shown in the drawings).

FIG. 6E shows blending vessel 310 according to this embodiment of system 301. FIG. 6F shows a lid 311, said lid 311 is configured to be placed on top of vessel 310. FIG. 6F further shows a vertical arm (rod) 317 extending downwards from lid 311. System 301 comprises a blade element 315 attached to the bottom of vertical arm 317. Blade element 315 comprises two rotatable blades 316 (extending sideways) and a smaller bottom rotatable blade 316′ (also extending sideways at a lower portion).

The blades 316 spin and blend the ingredients that are inserted into vessel 311. The bottom blade 316′ (typically placed near the bottom opening of vessel 310) is especially efficient as it contributes to the blending of the ingredients near the bottom opening making sure that the puree about to exit the bottom of vessel 310 (via the bottom opening) is adequately blended.

Optionally, each of blades 316 and/or 316′ has a sharp edge and a blunt edge. According to one embodiment, rotating the blade in its regular cutting mode also causes the mixing of the hummus product puree. According to another specific embodiment, the blade element 315 may rotate also in the opposite direction (i.e. wherein the blunt edges of the blades 316, 316′, are at the forward position during rotation and firstly engage the ingredients/puree). According to this specific embodiment, the blade element 315 may rotate in the regular blending direction (forward direction), and thereafter from time to time, in the opposite direction (backward direction) where the blunt edges of the blades 316, 316′ are at the forward rotational position and engage the ingredients/puree. Thus, the blade element 315 is spinnable in a forward direction and in a backward direction. This enables an efficient stirring of the hummus puree as the blunt ends of the blades 316, 316′ may effectively stir the puree and prevent bacteria accumulation (as it is known that when the puree is mixed it prevents becoming dry and bacteria accumulation). Other embodiments may comprise blades as explained herein, only with both sides being blunt, both sides being sharp or having a sharp side and a blunt side, etc.

The valve implemented at the bottom of blending vessel 310 is in the form of a sliding gate 319, shown in FIGS. 6G-6J. When the sliding gate 319 is in an open state the hummus product within the blending vessel 310 may be discharged therethrough. When the sliding gate 319 is in a closed state the hummus product within the blending vessel 310 is maintained therein.

The present invention vessel comprises a bottom discharge opening and a flexible sealing O-ring element (typically elastic). The O-ring may be attachably placed on the inner edge of the opening. In one embodiment, the upper portion of the O-ring is within the vessel and its bottom portion extends beneath the vessel (where the opening is at the bottom surface of the vessel without a lower extension). In another particular embodiment (shown in the figures), the bottom discharge opening comprises a cylindric extension 310c sealably attached to the bottom opening and extending downwards. The O-ring 324 is attached to the inner bottom portion of the cylindric extension 310c, such that its upper portion is within the cylindric extension 310c and its bottom portion extends downwards out of the cylindric extension 310c.

According to one embodiment the bottom portion of the cylindric extension comprises a small flange extending inwards. In this case, the O-ring comprises a middle channel (e.g. inner slit) with its interior facing outwards and bulging inwards such that the flange is placed in the O-ring inner channel and sealably attached thereto. The upper part of the O-ring is on the inner side of the cylindric extension.

According to another embodiment, the bottom portion of the cylindric extension comprises a small flange extending outwards. In this case, the O-ring comprises a middle channel (e.g. inner slit) with its interior facing inwards and bulging outwards such that the flange is placed in the O-ring inner channel and sealably attached thereto. The upper part of the O-ring is on the outer side of the cylindric extension.

According to yet another embodiment the bottom portion of the cylindric extension 310c comprises an inner channel (e.g. slit) portion (facing inwards). In this case, the O-ring comprises a middle flange bulging outwards such that the flange is placed within the cylindric extension inner channel and sealably attached thereto. The upper part of the O-ring is on the inner side of the cylindric extension.

The cylindric extension 310c has two parallel elongated track elements 325 attached and fixed thereto (or attached to the vessel 310 bottom). The gate 319 (typically in the form of a flat surface) is placed between two tracks 325t (in the form of inner channels) along the inner portions of the track elements 325. The gate 319 is slidable along tracks 325t and is configured to close and open the bottom opening.

As the O-ring 324 extends downwards out of the cylindric extension 310c, it extends downwards until it reaches a lower portion than that of the top of gate 319 (when opened). The O-ring 324 is flexible and when the gate 319 is opened the O-ring 324 is fully extended, and the puree may be discharged from the vessel 310. When the gate 319 is in a closed state the O-ring 324 is compressed on the top surface of gate 319 and as it is flexible, its bottom portion forcibly pushes down on gate 319, forming an excellent seal, and preventing the puree from leaking out of vessel 310.

The O-ring is mounted on the “bottom discharge opening of the vessel 310” (which can be considered the opening placed at the bottom surface of vessel 310 or, in another embodiment, considered at the bottom of extension 310c (which could also be considered as part of the interior of vessel 310)). Thus, the O-ring provides a sealed passageway coupling between the interior of the vessel 310 (i.e. either its top portion being in the interior of vessel 310 above the bottom surface or sealably attached to an extension (310c) thereof which could also be considered part of the interior of vessel 310) and the top of the sliding gate 319.

The amount of hummus product discharged (for a single dose) is according to the time the gate 319 remains open (or partially opened) during a single gate 319 opening-closing cycle (according to the control unit). The hummus product is discharged according to this embodiment, directly to the dish which is placed beneath the cylindric extension 310c in chamber 390. The control unit may keep the gate 319 open for a predetermined amount of time (controlled by the control unit).

The opening and closing of gate 319 is carried out by a piston unit 303 with an internal motor driving a piston rod 303r back and forth. The piston rod 303r is connected to gate 319 and configured to slide it back and forth. According to one embodiment, an elongated connecting element 305 (shown in FIGS. 6I-6J) connects between the piston unit 303 and the gate 319. The connecting element 305 comprises a channel 305c at a first end, configured to receive the piston rod 303r. The piston rod 303r is fixed within the interior of channel 305c. The connecting element 305 comprises two protruding elements 305p at its second end. The gate 319 comprises an elongated bulging portion 319b extending downwards therefrom (aligned perpendicularly to the gate opening/closing direction). The elongated connecting element 305 is placed such that the protruding elements 305p are placed between elongated bulging portion 319b. In this manner, when the piston rod 303r moves in a certain direction it moves connector 305 which moves bulging portion 319b (and thus gate 319) accordingly (by means of the protruding portions 305p, each configured to push bulging portion 319b in the corresponding direction. Thus, when the piston rod 303r moves in the gate opening direction the corresponding bulging portion 319b pushes the gate 319 to open along tracks 325t. When the piston rod 303r moves in the gate closing direction the corresponding bulging portion 319b pushes the gate 319 to close along tracks 325t. The piston unit is connected to and controlled by the control unit 399.

System 301 comprises a “partial” funnel element 313 extending diagonally upwards from a portion of the vessel rim 310e. The lid 311 therefore comprises an open “missing” sector portion such that each of the edges of the “missing” sector portion engages its corresponding funnel element 313 edge. Thus, a top open portion of the vessel 310 is provided for receiving ingredients into the vessel 310, from the containers 330 and 331. The containers 330 and 331 ingredient bottom outputs are placed above the funnel element 313 and/or above the open “missing” sector portion of lid 311 such that all of the ingredients dropping from the containers 330 and 331 drop into the vessel 310 (either directly or onto the funnel element 313 and thereafter into the vessel 310). The funnel element 313 assists in enabling a wider droppage area range of the ingredients from the containers 330 and 331 still having all of the ingredients end up in the vessel 310. Thus, the ingredient containers 330 and 331 bottom outputs (e.g. valves) are placed above the interior space of the vessel 310 or above the funnel element 313.

The system 301 comprises two ingredient containers 330 and 331 placed above and mounted on surface 386. The containers 330 and 331 have an O-ring and gate mechanism similar to the gate 319 and O-ring 324 mechanism explained herein in relation to the dispensing from vessel 310, mutatis mutandis.

The valves implemented at the bottom of blending containers 330 and 331 are in the form of sliding gates, shown in FIGS. 6K-6R. The piston unit, gate and tracks of container 330 will be referenced as the piston unit, gate and tracks of container 331, as they are typically the same, even though they may be of different sizes.

FIG. 6K shows each of the containers 330 and 331 and its corresponding tracks 425, sliding gates 419, piston units 403, connectors 405, all similarly connected at the bottom of the container openings in a similar manner as elements 325, 319, 303, 305, are connected at the bottom of vessel 310, mutatis mutandis. When the sliding gate 419 is in an open state the ingredients in the respective container may be discharged therethrough. When the sliding gate 419 is in a closed state the respective ingredients are maintained therein.

FIG. 6L shows the elements separately for a better understanding. A fixation element 426 (including bolts and corresponding nuts) is provided for each piston unit 403, to fix the piston units 403 to the surface 386. FIG. 6L further shows an adapter 427 which adapts the bottom of the respective container to the corresponding O-ring 424. The O-ring 424 may be in any one of the forms of O-ring 324, mutatis mutandis. FIG. 6M shows the adapter 427 having an upper portion sealably attached to the bottom opening of the corresponding container 331. The adapter 427 comprises a small flange extending outwards. In this case, the O-ring 424 comprises a middle channel (e.g. inner slit) with its interior facing inwards and bulging outwards such that the flange is placed in the O-ring 424 inner channel and sealably attached thereto. The two parallel elongated track elements 425 are fixedly attached to the sides of the adapter 427 (or container bottom). The gate 419 (typically in the form of a flat surface) is placed between two tracks 425t (in the form of inner channels) along the inner portions of the track elements 425. The gate 419 is slidable along tracks 425t and is configured to close and open the bottom opening.

As the O-ring 424 extends downwards out of the adapter 427, it extends downwards until it reaches a lower portion than that of the top of gate 419 (when opened). The O-ring 424 is flexible and when the gate 419 is opened the O-ring 424 is fully extended, and the respective ingredients may be discharged from the respective container. When the gate 419 is in a closed state the O-ring 424 is compressed on the top surface of gate 419 and as it is flexible, its bottom portion forcibly pushes down on gate 419, forming an excellent seal, and preventing the ingredients from leaking out of the respective container.

The O-ring is mounted on the “bottom discharge opening of the respective container” (which can be considered the opening placed at the bottom surface of the respective container or, in another embodiment, considered at the bottom of adapter 427 (which could also be considered as part of the interior of the respective container)). Thus, the O-ring provides a sealed passageway coupling between the interior of the respective container or adapter 427, (i.e. either the O-ring top portion being in the interior of the respective container or sealably attached to the bottom opening of the adapter (427) thereof which could also be considered part of the interior of the respective container) and the top of the sliding gate 419.

The amount of ingredients discharged (for a single blending cycle) is according to the time that the gate 419 remains open (or partially opened) during a single gate 419 opening-closing cycle (according to the control unit). The ingredients are discharged to a spatial area above the open portion of lid 311 or above the funnel element 313 (which both lead to vessel 310.

The opening and closing of gate 419 is carried out by the piston unit 403 with an internal motor driving a piston rod 403r back and forth. The piston rod 403r is connected to gate 419 and configured to slide it back and forth. According to one embodiment, the elongated connecting element 405 (shown in most of FIGS. 6K-6R) connects between the piston unit 403 and the gate 419. The connecting element 405 comprises a channel 405c at a first end, configured to receive the piston rod 403r. The piston rod 403r is fixed within the interior of channel 405c. The connecting element 405 comprises two protruding elements 405p at its second end. The gate 419 comprises an elongated bulging portion 419b extending downwards therefrom (aligned perpendicularly to the gate opening/closing direction). The elongated connecting element 405 is placed such that the protruding elements 405p are placed between elongated bulging portion 419b. In this manner, when the piston rod 403r moves in a certain direction it moves connector 405 which moves bulging portion 419b (and thus gate 419) accordingly (by means of the protruding portions 405p, each configured to push bulging portion 419b in the corresponding direction. Thus, when the piston rod 403r moves in the gate opening direction the corresponding bulging portion 419b pushes the gate 419 to open along tracks 425t. When the piston rod 403r moves in the gate closing direction the corresponding bulging portion 419b pushes the gate 419 to close along tracks 425t. The piston units are connected to and controlled by the control unit 399.

FIG. 6N shows a back view of the container 331. FIG. 60 shows a side cross-section view of the container 331. FIGS. 6P-6Q show additional back views of the containers and valves. FIG. 6R shows a cross-section of container 331 and respective gate 419.

The system 301 comprises a motor 360 for driving the rotation of blade element 315. The motor 360 is shown in FIG. 6S without the vertical wall 395 placed between it and vessel 310. FIG. 6T shows another angle of the motor 360 and vessel 310. FIG. 6U shows a side view of the motor 360 and vessel 310. The system 301 comprises a first pulley 366a extending from motor 360 and configured to be rotated by said motor 360. The first pulley 366a is mounted on a first spinning axle 367a spinnable by the motor 360 which it extends therefrom. The system 301 comprises a second pulley 366b mounted on a second spinnable axle 367b. A timing belt 366c is mounted on both pulleys 366a and 366b such that the rotation of one causes the rotation of the other, accordingly.

System 301 comprises a coupling element comprising an upper coupling portion 368a and a lower coupling portion 368b. The second spinnable axle 367b is connected to the upper coupling portion 368a. The upper coupling portion 368a is connectable to the lower coupling portion 368b (e.g. capable of spinning together as a single unit). The lower coupling portion 368b is placed above lid 311 and is fixedly attached to the upper portion of rod 317 which extends up and out of the lid 311. When the lower coupling rotates so does the rod 317 and blade element 315. The upper coupling portion 368a is connectable to the lower coupling portion 368b by means of complimentary bulging elements 368ab (of upper coupling portion 368a) and 368bb (of lower coupling portion 368b), shown in FIG. 6V. The complimentary bulging elements 368ab protrude downwards and the complimentary bulging elements 368bb protrude upwards.

When the upper coupling portion 368a engages lower coupling 368b (due to a spring force pushing it down as will be explained) bulging elements 368ab are placed at complementary recesses between bulging elements 368bb and bulging elements 368bb are placed at complementary recesses between bulging elements 368ab thus forming a united coupling unit movable together (shown in FIG. 6W). When the motor 360 is activated it rotates axle 367a and pulley 366a. The timing belt 366c turns and rotates pulley 366b and axle 367b, which rotate the united coupling comprised of engaged coupling portions 368a and 368b. Lower coupling portion 368b rotates arm 317 which rotates blade element 315 which grinds/chops and mixes the ingredients to form the puree.

The vessel 310 and attached elements are removable from system 301. This is advantageous e.g. as it prevents the need to wash the vessel 310 while it is still in the system (e.g. as explained regarding the washing feature explained herein). For this purpose, the upper coupling portion 368a is displaceable such that it is configured to be at an upper position (when removing/inserting the vessel 310) and in a lower position (engaging lower coupling portion 368b during the puree blending). Axle 367b comprises an internal vertical slit 367bt at its lower portion. Upper coupling portion 368a comprises an internal substantially horizontal rod (not shown) fixed thereon and placed through the vertical slit 367bt such that the upper coupling portion 368a is displaceable between an upper position (when the internal substantially horizontal rod engages the top portion of the vertical slit 367bt) and a lower position (when the internal substantially horizontal rod engages the lower portion of the vertical slit 367bt).

A spring latch mechanism is applied to the upper coupling portion 368a as follows. Surface 386 comprises a holding element 375 extending downwards therefrom and attached thereto. The holding element 375 comprises a holding surface 375s protruding sideways from a lower portion thereof. The upper coupling portion 368a comprises an upper flat surface 368as attached thereto. The upper flat surface 368as comprises at least one side protruding surface 368asp (a portion that extends beyond the upper coupling portion 368a main body portion). A spring 369 is placed between an upper bearing 376 (where axle 367b passes through the upper bearing 376) and the upper side of upper flat surface 368as. The spring 369 (wound around a lower portion of axle 367b) constantly pushes flat surface 368as (and thus upper coupling portion 368a) downwards, thus upper coupling portion 368a engages lower coupling portion 368b (in the united form as explained herein). When the upper coupling portion 368a is pushed upwards until the internal substantially horizontal rod engages the top portion of the vertical slit 367bt, the upper coupling portion 368a is rotated until the side protruding surface 368asp is on top of the holding surface 375s (which maintains it above it). Thus, upper coupling portion 368a is held in this upper position during vessel 310 removal/insertion. When the vessel 310 is inserted, the upper coupling portion 368a is rotated such that the side protruding surface 368asp is no longer on top of the holding surface 375s and spring 369 pushes upper coupling portion 368a downwards. The bulging elements 368ab are placed (possibly slightly rotated and adjusted by the user) at complementary recesses between bulging elements 368bb and bulging elements 368bb are placed at complementary recesses between bulging elements 368ab thus forming a united coupling unit movable together. When the motor drives and causes rotation of axle 367b this causes the upper coupling portion 368a to rotate (due to the horizontal rod in slit 367bt) and thus the united coupling unit to rotate, thus rotating arm 317 and blade element 315.

The vessel 310 (including lid 311, arm 317 and blade element 315) is removable from system 301 for cleaning and is replaceable by a second clean vessel 310 (including a second lid 311, second arm 317 and second blade element 315). When vessel 310 is removed the second clean vessel 310 may be inserted into system 301 and replace its function. This feature contributes to a long continuous function time without the need to stop and clean the entire system, what would necessitate a substantial system function cessation time for the system cleaning.

The track elements 325 (and gate 319), as they are attached and fixed to the bottom of vessel 310, are also removed during vessel removal. The second replacing vessel 310 inserted is identical to the first, and also has track elements 325, a gate 319, blade element 315, rod 317, lid 311, bottom coupling 368b, etc., as explained herein.

The vessel 310 is removable from system 301 and mountable thereon on corresponding fittings 312 (that are mounted on surface 387). The vessel 310 comprises a flat ring portion 310r fixedly attached thereto. Ring portion 310r surrounds vessel 310 and comprises two opposite tabs 310t. The tabs 310t are configured to be placed on corresponding fittings 312 comprising recesses complementary to said tabs 310t, such that the tabs 310t (and thus the entire vessel 310 and lid 311) remain immobilized when inserted therein. When the tabs 310t are in place, the vessel 310 is in place and the coupling portions 368a and 368b may be connected to rotate the blade element 315, as explained herein. When coupling 368a is lifted to its upper position (as explained herein) vessel 310 may be removed. The vessel rim 310r preferably comprises a handle 306 extending therefrom (and attached thereto) for ease of displacing vessel 310.

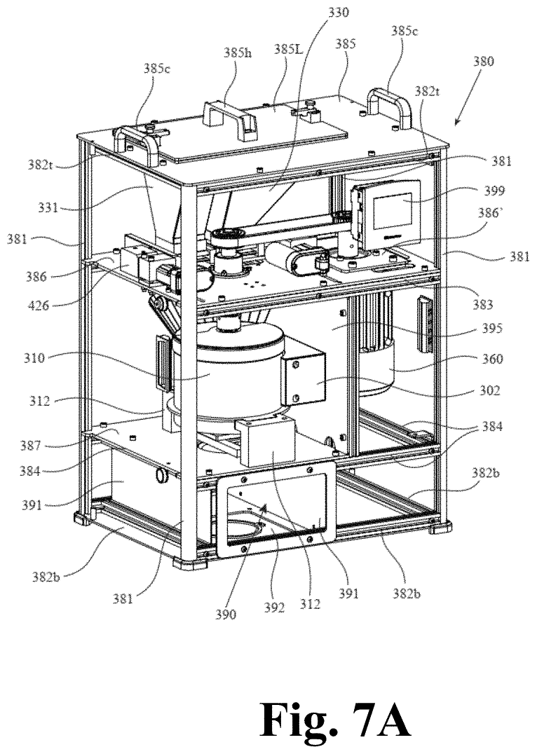

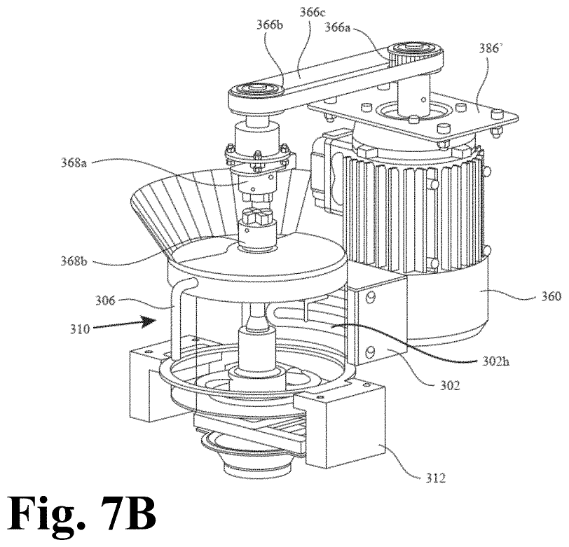

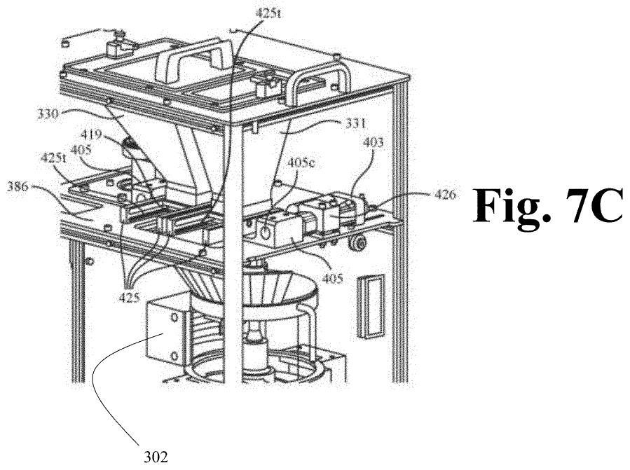

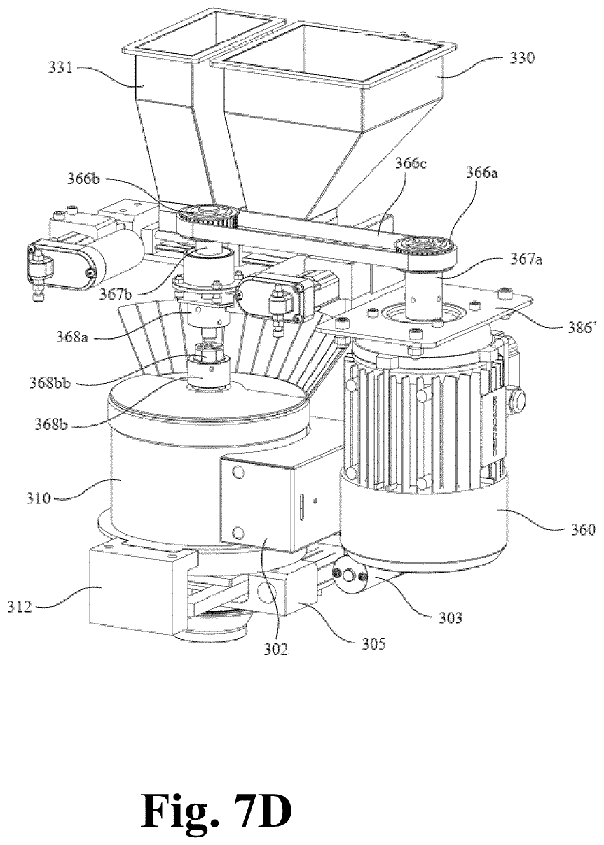

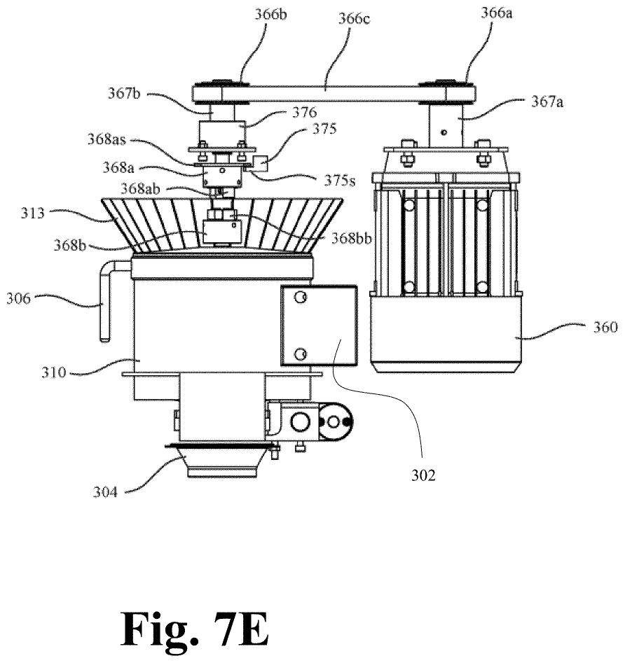

FIG. 6T shows the vessel 310 in transparent form. A funnel element 304 is shown attached to surface 387 from below (see FIGS. 6S, 6T, 6U and 6X), extending downwards within chamber 390. The funnel element 304 is configured to receive the puree hummus product from vessel 310 and reduce the puree droppage area such that the puree is dispensed onto a dish placed at a required focused location within chamber 390. Examples of the heating units 302 (and in some cases the heating elements 302h of heating unit 302) are shown in FIGS. 7A-7E.

According to an embodiment of the present invention, the system 301 comprises a weighing scale (e.g. a digital weight meter, weight device) within chamber 390, placed on the bottom surface 392. The weighing scale is coupled to the control unit 399 (as is piston unit 303) and may constantly provide the control unit 399 weight data of the weight thereon. In this manner during the dispensing of the puree from vessel 310 into a dish within chamber 390, the control unit 399 may open gate 319 and keep gate 319 open until a predetermined weight is reached (e.g. with subtracting the dish weight or taking the dish weight into account, etc., as known in the art). When the predetermined weight is reached, the control unit 399 sends a command to the piston unit 303 to close gate 319, thus stopping the discharging of the puree. In this manner, a predetermined dose of puree (having a predetermined weight) may be obtained after each discharge cycle.

A similar weighing scale may be placed on the surface that dish 22 is placed on (in system 1) for closing one or more of valves 19, 21 depending on the weight (as the weighing scale is also coupled to the control unit) as explained above, mutatis mutandis. Optionally, a similar weighing scale may be integrated within cup element 20, mutatis mutandis.

According to an embodiment of the present invention the system 301 container 330 may comprise a mixing element, such as a spiral assembly (e.g. similar to those of an ice coffee machine). FIGS. 6K-6L show an optional elongated spiral assembly 500 (and spiral assembly 600) mounted within container 330 (and container 331 respectively). For the sake of brevity and simplicity element 500 will be explained wherein element 600 is similar within container 331, mutatis mutandis. The elongated spiral assembly 500 is mounted between two opposing side walls of container 330. The elongated spiral assembly 500 comprises an elongated cylinder element 502 and a spiral element 504 mounted thereon (optionally attached thereto), such that the cylinder element 502 and spiral element 504 have a common central axis 510. The spiral element 504 is preferably flat (e.g. in the form of a flat sheet), and preferably substantially perpendicular to the cylinder element 502, i.e. each portion of the spiral element 504 is substantially perpendicular to respective cylinder element 502 portions which it contacts. Other embodiments may include an angle (e.g. a sharp angle) between the spiral element 504 and cylinder element 502.

The cylinder element 502 is configured to rotate/spin around its central axis (thus the entire elongated spiral assembly 500 rotates/spins around its central axis). A motor (not shown) is connected to the spiral assembly 500 and configured to rotate it (wherein the cylinder element 502 is mounted accordingly to enable the rotation, as known in the art, e.g. spiral assemblies used in ice coffee machines). The motor is coupled to the system control unit and power unit/power source. Optionally other motors in the system may be connected to the spiral assembly 500 enabling its rotation, etc.

This embodiment is advantageous as chickpeas in the container may be mixed once in a while preventing their sticking to one another. According to a preferred embodiment, the spiral assembly 500 engages the container 330 side walls along its length. The spiral element 504 engages the container 330 side walls that are parallel to its central axis 510 (different portions of spiral element 504 engage said side walls as it spins). This feature is advantageous as the spiral assembly 500 actually creates an upper space within the container 330 above the spiral assembly 500 and a lower space within the container 330 beneath the spiral assembly 500. The container food content (e.g. cooked chickpeas) above the spiral assembly 500 is separated from the content beneath the spiral assembly 500. As the spiral assembly 500 rotates, part of the food content falls to the container 330 lower space by the influence of gravity. Optionally, the spiral assembly 500 may rotate until (or even after) the space between the spiral assembly 500 and the bottom valve (sliding gate 319) is full with the food content. Then the spiral assembly 500 stops to rotate and separates between the food content in the upper and lower spaces. Then, the sliding gate 319 may open and the content from the lower space is dispensed (to the vessel, etc.). This can provide an efficient required quantity drop for a required dose. The food content quantity (e.g. a required dose for preparation) that drops below the spiral assembly 500 may be proportional to its rotation amount, frequency of rotation (RPM), etc. The control unit may activate the spiral assembly 500 to rotate for a certain amount in order to obtain a required quantity of the food content to drop to the container 330 lower space (and thereafter to the vessel, etc.).

According to another embodiment of the present invention, the spiral assembly 500 may be placed at the bottom of the container completely closing the container 330 and acting as a bottom valve (e.g. instead of sliding gate 319). Thus the food content quantity that drops out of the container to the vessel (e.g. a required dose for preparation) may be proportional to the spiral assembly 500 rotation, frequency of rotation, as explained above.

According to another embodiment (either with the spiral assembly 500 for only mixing the food content or without it), a second container valve assembly (not shown) e.g. a sliding door (as explained herein), may be placed above sliding gate 319 separating the container space above it and beneath it. Optionally, the second valve assembly may be placed in the center of a flat partition that separates between the container space above it and beneath it. When opened the food content above the second valve assembly may fall by the influence of gravity and fill the space between the two container valve assemblies. Then the second valve assembly closes and a required food content quantity is ready to be dispensed to the vessel (and dropped when the bottom valve assembly opens). This allows for a controlled dose droppage. In other words the container comprises a lower valve assembly at its bottom, and an upper valve assembly separating between the container interior space above it and beneath it.

The controlled dose droppage as explained regarding the above embodiments may be advantageous, for example with the embodiment of the heating elements in the container maintaining the chickpeas hot and processing (i.e. grinding and preparing to be served) only a dose quantity, to be served hot. All of the features/elements of the containers 330 and 331 explained herein may also be in addition and in conjunction with the mixing elements as explained herein.

According to yet another embodiment of the present invention the system 301 may comprises a top container 730 functioning as an additional cartridge, placed above container 330, capable of containing more chickpeas (or other respective ingredients) to be processed and prepared for the puree (see FIG. 6X). The top container 730 is also referred to herein as cartridge 730 interchangeably. The cartridge 730 comprises a bottom opening and a bottom valve to dispense its ingredient content into the respective container 330. Also, a cartridge 731 is placed above container 331 in a similar manner (typically containing a different ingredient), mutatis mutandis. For the sake of brevity and simplicity, the embodiment will be explained in relation to cartridge 730 and container 330, but is also similar with respect to cartridge 731 and container 331, mutatis mutandis.

According to an embodiment of the present invention, the cartridge 730 sits on horizontal surface 385. The bottom opening of cartridge 730 is coupled to a top opening of container 330, or may allow droppage (by the influence of gravity) of its ingredient content into the interior of container 330 as it is above it (e.g. as container 330 has a respective top opening to receive the dropped ingredients, e.g. the top opening is the entire top of container 330). In some embodiments the cartridge 730 is placed instead of lid 285L and handle 385h (which in this case the horizontal surface 385 comprises an opening that enables the above droppage/dispensing features.

According to an embodiment of the present invention one or more of the cartridges comprise a mixing element similarly as described in connection to the mixing elements within containers 330 and 331 (e.g. elements 500 and 600 within containers 330 and 331 respectively), mutatis mutandis. According to an embodiment of the present invention, the mixing element is a spiral assembly similar to elements 500 and 600. FIG. 6X shows an optional elongated spiral assembly 700 (and 800) mounted within cartridge 730 (and 731). As said, for the sake of brevity and simplicity, element 700 will be explained wherein element 800 is similar within cartridges 731, mutatis mutandis.

The elongated spiral assembly 700 is mounted between two opposing side walls of cartridge 730. The elongated spiral assembly 700 comprises an elongated cylinder element 702 and a spiral element 704 mounted thereon (optionally attached thereto), such that the cylinder element 702 and spiral element 704 have a common central axis 710. The spiral element 704 is preferably flat (e.g. in the form of a flat sheet), and preferably substantially perpendicular to the cylinder element 702, i.e. each portion of the spiral element 704 is substantially perpendicular to respective cylinder element 702 portions which it contacts. Other embodiments may include an angle (e.g. a sharp angle) between the spiral element 704 and cylinder element 702.

The cylinder element 702 is configured to rotate/spin around its central axis (thus the entire elongated spiral assembly 700 rotates/spins around its central axis). A motor (not shown) is connected to the spiral assembly 700 and configured to rotate it (wherein the cylinder element 702 is mounted accordingly to enable the rotation, as known in the art, e.g. spiral assemblies used in ice coffee machines). The motor is coupled to the system control unit and power unit/power source. Optionally other motors in the system may be connected to the spiral assembly 700 enabling its rotation, etc.

This embodiment is advantageous as chickpeas in the cartridge may be mixed once in a while preventing their sticking to one another. According to a preferred embodiment, the spiral assembly 700 is placed preferably at the bottom of cartridge 730 and engages the cartridge 730 side walls along its length. The spiral element 704 engages the cartridge 730 side walls that are parallel to its central axis 710 (different portions of spiral element 704 engage said side walls as it spins). This feature is advantageous as the spiral assembly 700 actually creates an upper space within the interior of cartridge 730 (above the spiral assembly 700) which is separated from the space beneath it (preferably completely closing the cartridge 730 and acting as a bottom valve). As the spiral assembly 700 rotates, part of the ingredient food content falls to the container 330 by the influence of gravity. Optionally, the spiral assembly 700 may rotate until the interior of container 330 is filled with the ingredient food content (or is full with a typical quantity of the ingredient food content to be dispensed to the vessel, etc.). Then the spiral assembly 700 stops to rotate. This can provide an efficient required quantity drop for a required dose. The food content quantity (e.g. a required dose for preparation) that drops below the spiral assembly 700 into the container 330 may be proportional to its rotation amount, frequency of rotation (RPM), etc. The control unit may activate the spiral assembly 700 to rotate for a certain amount in order to obtain a required quantity of the food content to drop to the container 330 (and thereafter to the vessel, etc.).

In this manner the spiral assembly 700 acts as a bottom valve of cartridge 730. Thus the food content quantity that drops out of the cartridge 730 to the container 330 (and thereafter to the vessel), e.g. a required dose for preparation, may be proportional to the spiral assembly 700 rotation, frequency of rotation, as explained above. This allows for a controlled dose droppage.

The cartridge 730 may comprise heating elements as explained in relation to container 330, mutatis mutandis. The cartridge 730 may be a type of pressure cooker (configured to cook the raw chickpeas at high pressure) as explained in relation to the pressure cooker of container 330, mutatis mutandis. All of the features/elements of the containers 330 and 331 explained herein may also be in the cartridges 730, 731 in addition and in conjunction with the mixing elements as explained herein (e.g. heating elements, pressure cooker, etc.), mutatis mutandis, and was not detailed for the sake of brevity and simplicity. Furthermore, an embodiment may include the mixing elements not at the bottom (e.g. in the middle) of the cartridge and a valve (e.g. the valve with sliding gate 319, etc.) at the bottom of the cartridge, in a similar manner as explained in relation to the embodiment of the containers with the mixing elements separating between an upper portion and lower portion of the container interior, mutatis mutandis, and was not detailed for the sake of brevity and simplicity. According to one embodiment, the system 301 may comprise the cartridge 730 and without the container 330 (in this case the ingredient content will fall directly to the vessel 310 (or on top of rim 310r), etc.).

The cartridge 730 may have all of the elements of container 330, mutatis mutandis.

The cartridge 730 may have a volume larger than container 330 (e.g. twice the volume, three times the volume, four times the volume, five times the volume, etc.). The cartridge 731 may have a volume larger than container 331 (e.g. twice the volume, three times the volume, four times the volume, five times the volume, etc.). This increases the storage volume for ingredients (e.g. chickpeas) to be prepared, and may provide hot dosages (in the embodiments with the cartridge heating elements) to be dropped to the vessel to be processed and prepared. The length/width/height of the cartridges may be according to the above and in accordance to the system element sizes as explained herein. The sizes of the spiral assemblies explained herein may also be in accordance with the system element sizes as explained herein. Optionally, the materials of the spiral assemblies explained herein may be similar to those of spiral assemblies of ice coffee machines.

According to another embodiment of the present invention (shown for example in FIGS. 6Y-6Z) the cartridge 730′ comprises a mixing element 770 comprising a spinning bar 771 fixedly mounted on an axle 775. The axle 775 is spinnable, connected to a motor (not shown) that provides the power to spin it. Typically, the motor is placed externally to cartridge 730′ wherein the axle 775 protrudes one of its walls (e.g. side walls). The spinning bar 771 is fixedly mounted on the axle portion within the cartridge 730′. Two receptacles 772 are each fixedly connected to one edge of the spinning bar 771. The receptacles 772 each comprise a top opening having a top opening edge 772e and a hollow interior (e.g. having a hollow cylindrical shape, a cup shape, a bowl shape, a hollow box shape, etc.). The top opening edge 772e is always positioned away from the axle 775. The bottom of receptacles 772 are always positioned facing axle 775 and fixedly attached to the edges of spinning bar 771. In this manner, the opening edges 772e are always facing outwards, away from the axle 775 and along the most exterior (imaginary) spinning circular track 776 which the mixing element 770 forms during spinning.

The cartridge 730′ comprises a bottom valve 777 (e.g. such as the bottom valve with the sliding gate 319, as explained in detail herein). When the spinning bar 771 is in a vertical position (in FIG. 6Y) the opening edge 772e of the bottom positioned receptacle 772 faces downwards and engages the bottom surface of cartridge 730′ at a location which surrounds the valve 777 (i.e. surrounds the valve opening from right above it). In this position the valve 777 may be in an open state and the ingredient content (e.g. chickpeas) within the interior of the bottom positioned receptacle 772 is dispensed into the container 330 (or in some embodiments directly to vessel 310 or on top of rim 310r). This allows for a dosage dispensing which each dosage is in accordance to the interior volume of the bottom receptacle 772. After the dispensing, the valve 777 closes and the spinning of spinning bar 771 continues.

The control unit as described herein may control the function of the motor driving axle 775 and valve 777 (both which may be connected to the system power source), such that when the spinning bar 771 is in a vertical position the spinning stops, the valve 777 opens, then closes, and then the spinning continues. FIG. 6Z shows a position during spinning when the spinning bar 771 is not in a vertical position. The cartridge 730′ is preferably filled with ingredient content to a level height such that when the receptacle 772 engages the cartridge 730′ floor, it is in a position filled with the ingredient content.

The two receptacles 772 may have different sizes for different required dosages to be dispensed. Some embodiments may have only one receptacle connected to a spinning bar (with an appropriate length) connected to the axle.

The present invention may comprise more spinning bars and receptacles (e.g. 4 receptacles connected to the edges of an X-shaped bar arrangement mounted on the axle at the center of the X-shape, mutatis mutandis).

The mixing element 770 is advantageous as it allows also the mixing of the ingredient content (e.g. chickpeas) and also a dosage dispensing with the dosages according to a required quantity. For example, the dosage required may be according to one time the receptacle is positioned at the bottom and dispensed/emptied. According to another example, the dosage required may be according to two or more cycles, i.e. two or more times a receptacle is positioned at the bottom and dispensed/emptied. Also, a sum of the volumes of 2 receptacles with different volume sizes may provide a certain dosage amount. The illustration of FIGS. 6Y-6Z (as all of the drawings) are exemplary (e.g. for tangibility) and certain elements therein may be different in size, shape, etc.

The controlled dose droppage as explained regarding the above cartridge embodiments may be advantageous, for example with the embodiment of the heating elements in the cartridge maintaining the chickpeas hot and processing (i.e. grinding and preparing to be served) only a dose quantity, to be served hot.

The present invention method as explained herein also includes all of the method steps explained in conjunction with the description of the embodiments of systems 301 (and also systems 1, 100).

According to another aspect of the present invention, the hummus product ingredients are discharged directly from the containers into the serving dish and the blade element is configured to move into the interior space of the serving dish and blend the ingredients within the interior space of the serving dish into the hummus product. The blade element according to this aspect of the invention is small enough such that it is configured to be placed within the dish. As the chickpeas coming from the chickpeas container to the serving dish may be hot, the hummus product produced (right after the blending) according to this aspect of the present invention, may also be hot and may be served hot.

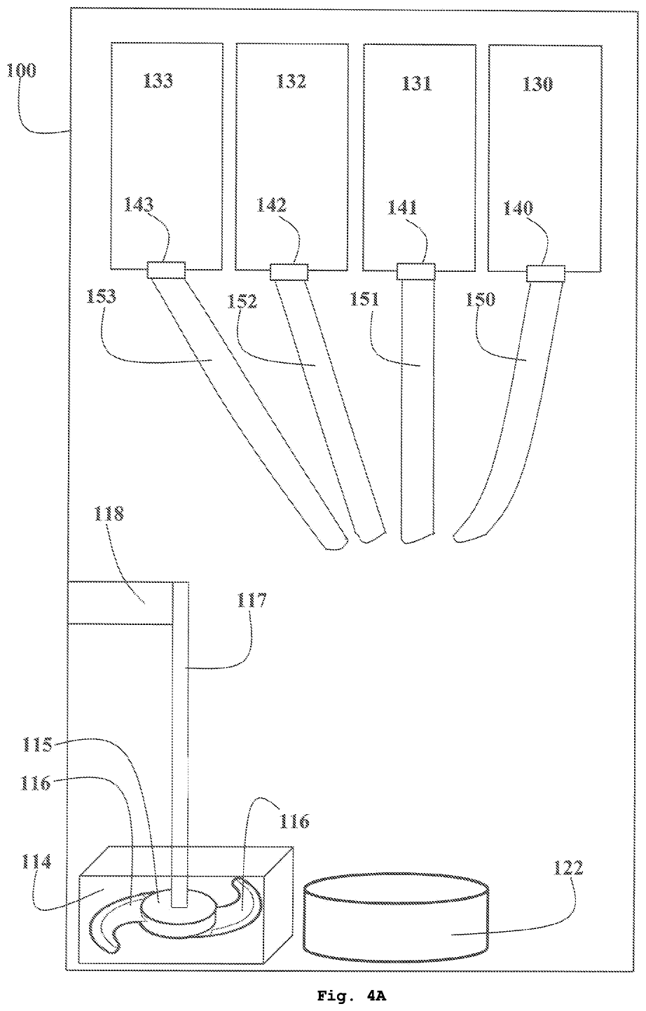

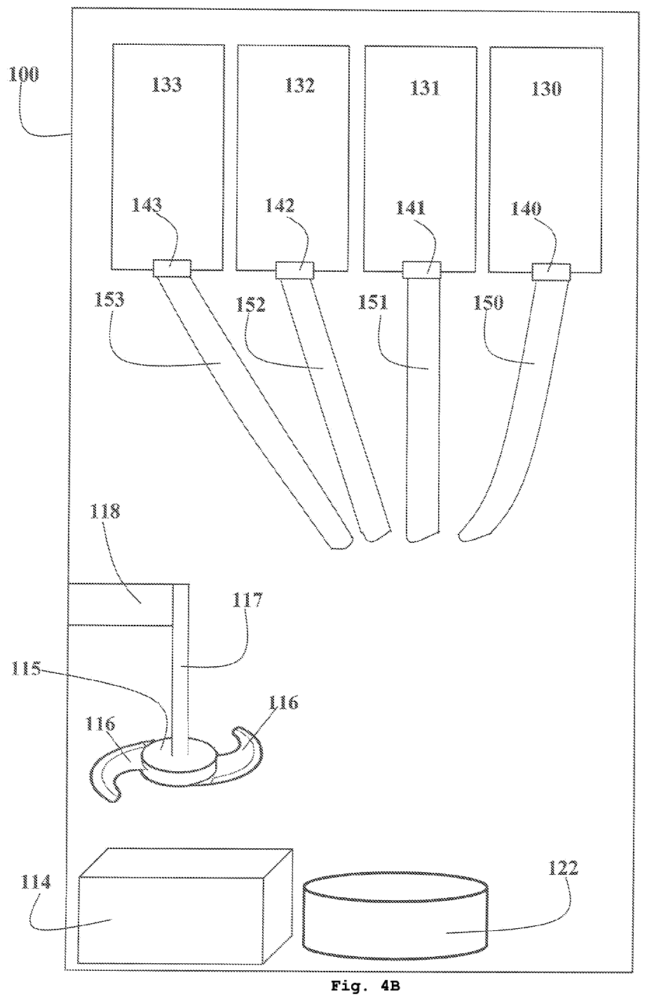

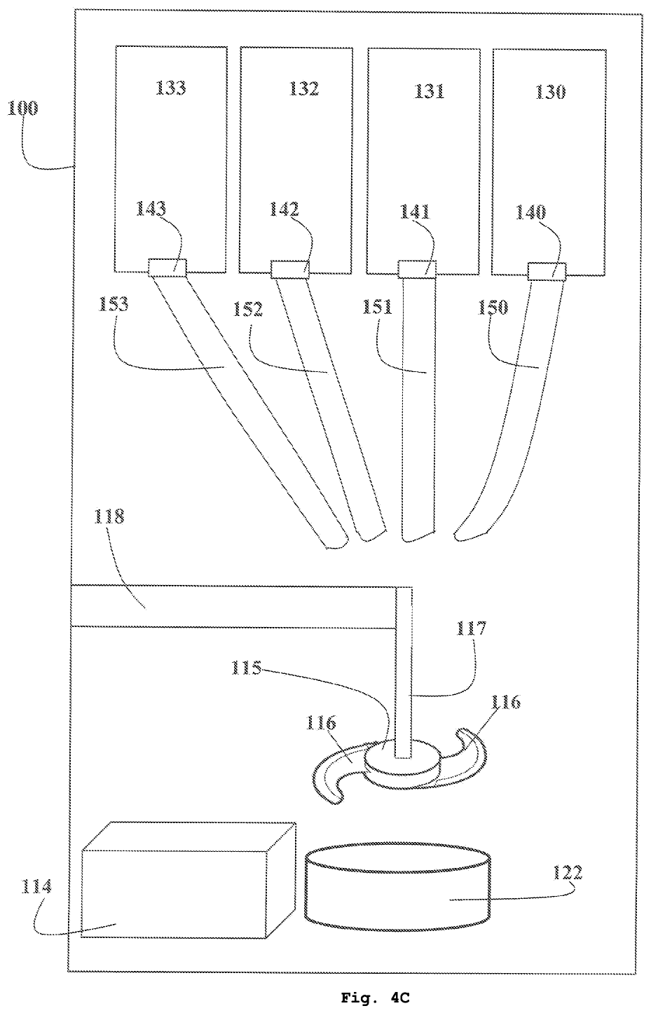

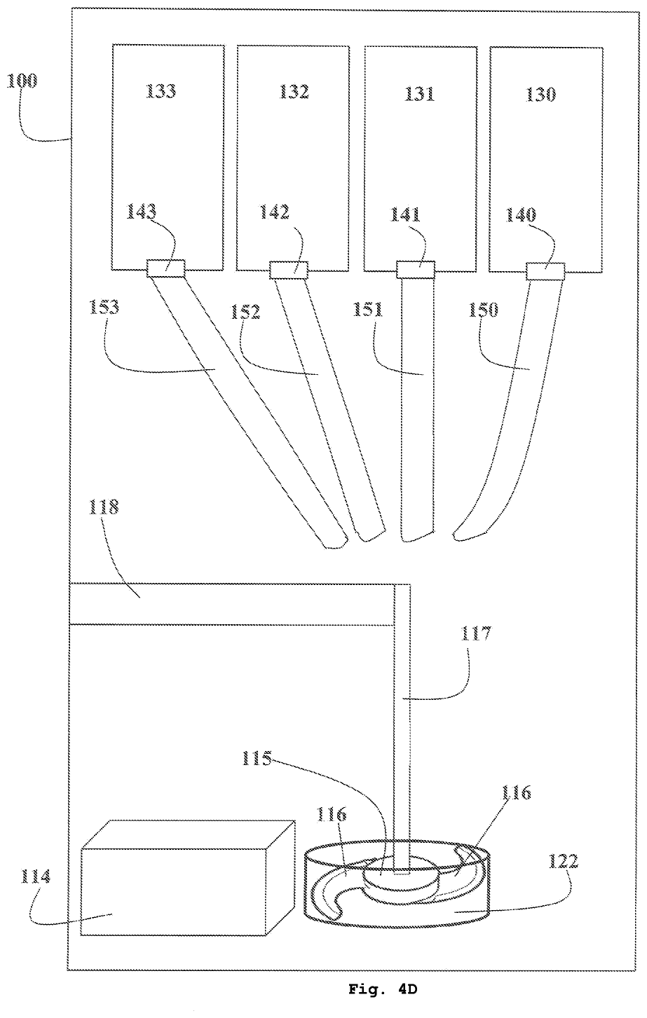

According to one embodiment of this aspect of the invention (as shown in FIGS. 4A-4D), the system 100 comprises the ingredient containers as described herein. Each of the ingredient containers 130, 131, 132 and 133 bottom surfaces comprise a corresponding valve 140, 141, 142 and 143 such that when in an open state the ingredients within the respective ingredient containers 130, 131, 132 and 133 may be discharged therethrough. Respective transport paths 150, 151, 152 and 153 extend from the respective valves 140, 141, 142 and 143 downwards (or diagonally downwards) to a spatial area above the serving dish 122 (first spatial area) such that ingredients passing therethrough will fall into the interior of serving dish 122 (second spatial area) under the influence of gravity. In this manner the respective ingredients discharged from the respective containers 130, 131, 132 and 133 and pass via the respective transport paths 150, 151, 152 and 153 to the area above (or within) serving dish 122 thereafter fall into serving dish 122.

The amount of ingredients from each container (for a single blending cycle dose) that fall into dish 122 during a single blend cycle is according to a predefined amount which is dispensed (according to the respective level sensor) in the respective ingredient container.

As explained herein, in some alternative embodiments the ingredient containers bottom surfaces comprise openings where the ingredients are discharged therethrough, and wherein respective valves are placed within the respective transport paths extending from the bottom openings to the spatial area within or above the serving dish 122.

The present invention comprises a blade grinding unit (portions of which substantially function as a blade grinder) configured to chop the ingredients within the serving dish 122 while mixing them, by means of a high-speed spinning blade element 115 placed within the interior of serving dish 122. The blade element 115 comprises at least one blade 116 (two blades 116 are shown in the embodiment of FIGS. 4A-4D). The at least one blade 116 is placed substantially horizontally and spins horizontally around a central axis such that it can perform the grinding and mixing action of the ingredients within the serving dish 122 so as to prepare the hummus product.

According to one embodiment, the blade element 115 is fixed to the end of an arm element (fixed to a surface of system 100, e.g. one of the side external walls of external housing 80 shown in FIG. 3). The system 100 comprises a water container 114 typically near the serving dish 122 where the blade element 115 is placed when not in use. The water container 114 is filled with water such that the blade element 115 can spin therewithin, cleaning itself from hummus-product remains of a prior blending. The arm element is configured to move the blade element 115 between two positions. One position is within the interior of the serving dish 122 to blend the ingredients of the hummus product. The other position is within the water container 114 for cleaning the blade element 115 after a blend cycle so that the blade is cleaned for a next use. The blade element 115 spins for a predetermined period for the blend action within serving dish 122. The blade element 115 also spins for a predetermined period for cleansing spins within water container 114.

The arm element may be mechanically constructed in various forms. For example, the arm may comprise a plurality of segments, each segment with a hinge joint therebetween powered by a motor (or more than one motor). Other embodiments may include a hydraulic based arm e.g., with a plurality of segments, each segment with a hinge joint therebetween powered by a hydraulic unit.

The embodiment of FIGS. 4A-4D shows an arm element having a substantially vertical portion 117 and a substantially horizontal portion 118. The vertical portion comprises an electric motor (not shown) configured to rotate the blade element 115 (driving the rotation of the blade element 115) causing it to spin such that it can chop and mix the ingredients into a hummus product. According to one embodiment, the motor is configured to rotate an axle extending downward therefrom wherein the center of the blade element 115 is mounted on and fixed to the axle. Thus, the motor is configured to cause the axle (and thus the blade element 115) to spin. Optionally, motors that are used may be motors similar to those commonly used in commercial blenders, food processors, various blade grinders and the like or similar motors.

The horizontal portion 118 may be a telescopic arm configured to expand (i.e. lengthens) and contract (i.e. shortens) horizontally, wherein the expansion and contraction may be based on a hydraulic mechanism. The vertical portion 117 may be a telescopic arm configured to expand (i.e. lengthens) and contract (i.e. shortens) vertically, wherein the expansion and contraction may be based on a hydraulic mechanism.

FIG. 4A shows the mode in which the blade element 115 is placed within the water container 114 prior to blending. The ingredients from containers 130, 131, 132 and 133 pass through via valves 140, 141, 142 and 143, via the respective transport paths 150, 151, 152 and 153 and are dropped into dish 122.

FIG. 4B shows the mode in which the blade element 115 is lifted to be placed in dish 122 for blending. Vertical telescopic arm portion 117 is contracted and blade element 115 is lifted upwards.

FIG. 4C shows the mode in which the blade element 115 is moved horizontally to be placed above dish 122. Horizontal telescopic arm portion 118 is expanded until blade element 115 is above dish 122.

FIG. 4D shows the mode in which the blade element 115 is lowered and placed within dish 122 for blending. Vertical telescopic arm portion 117 is expanded and blade element 115 is lowered until it is at an appropriate level within dish 122 for blending. Then, the blade element 115 motor (typically placed within arm portion 117) is activated and the ingredients blended.

After the blending, the blade element 115 is moved vertically upwards to be placed above dish 122. Vertical telescopic arm portion 117 is contracted moving blade element 115 upwards until it is above dish 122 (as the position of FIG. 4C). Then, the blade element 115 is moved horizontally to be placed above water container 114, i.e. horizontal telescopic arm portion 118 is contracted until blade element 115 is above water container 114 (as in FIG. 4B). Then, the blade element 115 is lowered to be placed in the water container 114, by vertical telescopic arm portion 117 being expanded and blade element 115 lowered downwards until entering water container 114 (as in FIG. 4A). The blade element 115 motor is then activated and the blade element 115 is cleansed. The motor then stops and the blade element 115 remains in the water container 114 and is ready for the next blending cycle use.

According to an embodiment of this aspect of the invention a lid (configured to cover dish 122 and typically having a greater diameter) is mounted on the arm element above the blade element 115, such that the distance between the lid and the blade element 115 is such that when the lid engages the top circumference of dish 122 the blade element 115 is in the correct height position to blend the hummus product ingredients.

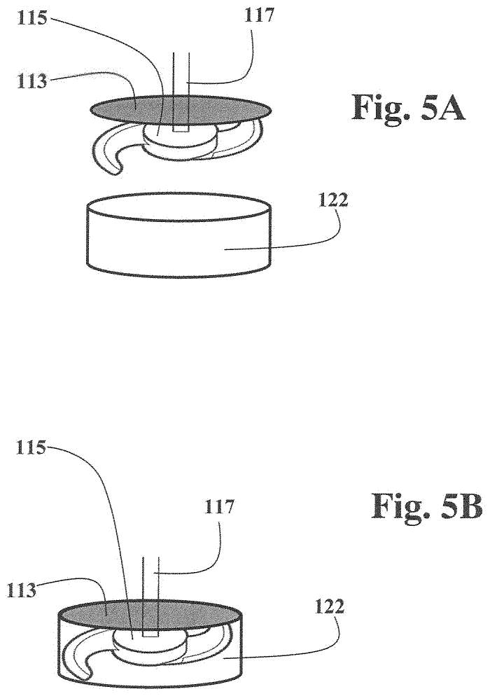

FIG. 5A shows the lid 113 mounted on the vertical telescopic arm portion 117 (wherein vertical telescopic arm portion 117 passes through the center of lid 113). Both the lid 113 and the blade element 115 are in a position above dish 122. FIG. 5B shows the lid 113 engaging the top circumference of dish 122 wherein the blade element 115 is within the dish 122 interior, in the correct height position to blend the hummus product ingredients.

The water container 114 may comprise A drainage hose extending from a dedicated valve at the bottom of the water container 114 that leads to drainage (e.g. an external drainage port) where the dirty water (with the hummus product residues) is disposed of. The water container 114 may comprise a water hose coupled to an external water source (e.g. external water faucet) to fill the empty water container 114 (after drainage) with fresh water. The water hose may be turned on and off mechanically or optionally electrically.

According to an embodiment of this aspect of the present invention, instead of the water container 114, a housing container (not shown) comprising a water hose with a plurality of nozzles is provided. The nozzles face (i.e. are configured to squirt on) the blade element 115, cleansing it for use in blending in the next cycle. A drainage hose may be provided extending from a dedicated valve at the bottom of the housing container that leads to drainage (e.g. an eternal drainage port) where the dirty water (with the hummus product residues) is disposed of. The water hose is coupled to an external water source (e.g. external water faucet). The water hose may be turned on and off mechanically or optionally electrically. The present invention according to this embodiment functions as a “mini-dishwasher” unit.

The motor/s, the water hose, valves, level sensors, etc., are all coupled to the control unit (and optionally to the power unit) and function as described herein, mutatis mutandis.

According to this aspect of the present invention, the ingredient containers, the valves as explained herein, the transport paths, the rotation speed of the blade element, the chickpeas container (with its heating elements), the other ingredient containers, level sensors (not detailed for the sake of brevity), blade element motor, control unit, power unit, operation buttons, external housing, conveyor, sliding door, cavity, etc., are all as explained herein with regards to the first aspect of the invention (according to any one of its embodiments), mutatis mutandis, and have not been detailed for the sake of brevity).

For example, in the embodiments with cavity 90 the blade element 115 enters the dish 122 for blending while dish 122 is placed within cavity 90.

It should be clear that in this aspect of the present invention, in system 100 the containers 130-133 may also comprise the spiral assemblies 500, 600, as explained in detail in relation to containers 330 and 331, mutatis mutandis. Also, in system 1 containers 30-33 may also optionally comprise the spiral assemblies 500, 600, (either with the bottom valve 19 embodiment, faucet embodiment, etc.) as explained in detail in relation to containers 330 and 331 as well, mutatis mutandis. Also, system 1 may comprise the cartridges as explained herein, mutatis mutandis.

This aspect of the present invention also includes a corresponding method. The present invention relates to a method for preparing and dispensing a puree in a plurality of dispensing cycles, wherein each cycle comprises the following steps:

A) transferring one or more ingredient dosages, each from a respective ingredient container, into a serving dish to be blended in a blending cycle;

B) maneuvering a blade element fixed to the end of an arm element, into the interior of said serving dish;

C) blending the one or more ingredients inside the serving dish into a puree;

D) maneuvering the blade element, into the interior of a water container;

E) cleaning said blade element by spinning the blade element within the water container;

F) optionally, disposing of the water and puree residues from the water container and filling said water container with fresh water;

wherein step A preferably comprises rotating a spiral assembly within said respective ingredient container.

Preferably, the respective one or more ingredient dosages is proportional to the spiral assembly rotating (i.e. the respective spiral assembly rotation in the respective ingredient container, explained herein in detail with respect to items 500, 600).

Preferably, the method further comprises a step prior to step A comprising: transferring at least one of said one or more ingredient dosages from a respective cartridge (e.g. 730, 731) into a corresponding container by rotating a spiral assembly within said respective cartridge.

Preferably, the method further comprises a step prior to step A comprising:

transferring at least one of said ingredient dosages from a respective cartridge into a corresponding container by the following steps:
providing the cartridge having a spinning bar and at least one receptacle having an opening and a hollow interior, each receptacle fixedly connected to one edge of the spinning bar;
providing the cartridge comprises a bottom valve having an opening; and spinning the spinning bar until the opening faces and surrounds the valve opening;
opening the valve (and typically after the content drops—closing the valve).

Preferably, the puree is a hummus product.

According to another embodiment, the present invention relates to a method for preparing and dispensing a puree in a plurality of dispensing cycles, wherein each cycle comprises the following steps:

A) transferring one or more ingredient dosages, each from a respective ingredient container, into a serving dish to be blended in a blending cycle;

B) maneuvering a blade element fixed to the end of an arm element, into the interior of said serving dish;

C) blending the one or more ingredients inside the serving dish into a puree;

D) maneuvering the blade element, into the interior of a housing container;

E) cleaning said blade element by squirting water on said blade element;

F) optionally, disposing of the water and puree residues within the housing container;

wherein step A preferably comprises rotating a spiral assembly within said respective ingredient container.

Preferably, the respective one or more ingredient dosages is proportional to the spiral assembly rotating.

Preferably, the method further comprises a step prior to step A comprising:

transferring at least one of said one or more ingredient dosages from a respective cartridge into a corresponding container by rotating a spiral assembly within said respective cartridge.

Preferably, the method further comprises a step prior to step A comprising:

transferring at least one of said ingredient dosages from a respective cartridge into a corresponding container by the following steps:
providing the cartridge having a spinning bar and at least one receptacle having an opening and a hollow interior, each receptacle fixedly connected to one edge of the spinning bar;
providing the cartridge comprises a bottom valve having an opening; and spinning the spinning bar until the opening faces and surrounds the valve opening;
opening the valve (and typically after the content drops—closing the valve).

Preferably, the puree is a hummus product.

The methods according to this aspect of the present invention may comprise placing the dish on the conveyor, etc., as described herein with respect to the system.

According to an embodiment of the present invention, the present invention ingredient containers may be aseptic packages (that have overgone an aseptic processing). The aseptic packages may comprise an opening configured to connect to a bottom container valve (or a bottom container opening) as explained herein. The aseptic packages are configured to contain the necessary ingredients for preparing the puree/hummus product. The ingredients may be discharged from the aseptic packages opening in a similar manner as explained in relation to the ingredient containers herein (e.g. containers 30-33, 130-133, 330-333), mutatis mutandis.

According to yet another aspect of the present invention, the system (1, 100, 301) comprises a mashing unit. The mashing unit may be instead of, or in addition to the blade element (15, 115, 315). The mashing unit is fixed to an upper surface and comprises a vertical arm portion extending downwards. Optionally, the vertical arm portion may be a telescopic arm configured to expand and contract vertically, wherein the expansion and contraction may be based on a hydraulic mechanism (as explained herein), piston unit (as explained herein), etc. The bottom of the arm portion comprises a bottom mashing element connected thereto, configured to mash the cooked ingredients within the vessel. The cooked ingredients from the ingredient containers may comprise cooked potatoes for preparing mashed potatoes, chickpeas for preparing a hummus product, water, or other ingredients as explained herein.

According to one embodiment, the bottom mashing element is in the form of a flat sheet (e.g. having a shape which is round, circular, oval, rectangular, square), optionally comprising a plurality of apertures that assist in the mashing procedure, as known in the art. For example, the bottom mashing element may have the form of a perforated flat sheet. The bottom mashing element is pushed downwards and pulled upwards (the telescopic arm expanding downwards and contracting upwards) for several times thus mashing the ingredients, eventually obtaining a mashed puree. The mashed puree may be dispensed as explained herein.

According to an embodiment, the bottom mashing unit may be used with systems 1, 100 and 301, as explained herein, by having the bottom mashing element replace the blade elements 15, 115, 315, respectively, mutatis mutandis. The blade elements 15, 115, 315 may be disconnected to the respective upper arm portion and the mashing element may be connected thereto instead. Optionally, after the mashing forming the puree, the heating elements attached to the vessel maintain the puree fresh, hot and without bacteria (as explained herein).

The mashing element flat sheet length/diameter is usually between 5 and 15 cm. Its thickness is usually between 1 mm and 4 mm. The aperture diameters may vary and be for example, between a couple millimeters and one or more centimeters. The distances between two adjacent apertures may be, for example, between 5 mm and 20 mm.

The mashing element flat sheet is preferably made of a material selected from the group consisting of metal, steel and plastic.

The present invention system blade elements 16, 116, 316, 316′, may each comprise one of the following: (a) two sharp edges, (b) two blunt edges or (c) a sharp edge and a blunt edge.

According to an embodiment of the present invention, any one of the mixing elements may comprise heating elements attached thereon. According to a particular embodiment, any one of spiral assemblies 500, 600, 700, 800, may comprise heating elements attached thereon (not shown). These heating elements cause the spiral assemblies 500, 600, 700, 800 to become hot and heat the ingredients within each of their respective containers/cartridges (e.g., to prevent formations of bacteria coliforms, salmonella, etc., therein and to enable serving hot dish portions). These heating elements on the spiral assemblies 500, 600, 700, 800, are coupled to the system control unit and power unit.

According to an embodiment of the present invention, the present invention system comprises a steam unit (not shown) coupled to the interior of containers (330, 331) and/or cartridges (730, 731), for heating the ingredients therein. The steam unit comprises a water heating container for producing the steam and appropriate piping that is configured to lead the steam to an inlet at the containers (330, 331) and/or to an inlet at the cartridges (730, 731). The containers (330, 331) and/or cartridges (730, 731) may also comprise an appropriate outlet. Optionally the outlets lead back (by piping) to the steam unit for circulation, thereby providing an efficient heating circulation, as known in the art. This also can contribute to prevent formations of bacteria coliforms, salmonella, etc. The steam unit is coupled to the system control unit and power unit.

According to an embodiment of the present invention, the system comprises a vibrating surface (not shown) within chamber 390, placed on the bottom surface 392. The vibrating surface is configured to provide vibrations to the dish which sits on it. This prevents the puree (e.g., hummus product) from piling up in the dish, thereby lowering/leveling the puree height to be leveled within the dish. This prevents spillages and messiness of the system. The vibrating surface comprises elements enabling its vibration, as known in the art, and is coupled to the system control unit and to the system power unit. Some embodiments may comprise the vibrating surface being integrated with the weighing scale, mutatis mutandis.

According to a preferred embodiment of the present invention, the present invention system comprises a temperature adjusting unit. The temperature adjusting unit may be an air heating unit (not shown), configured to create and supply a hot air stream, and to pass the hot air into a respective temperature adjusting area to elevate the temperature of the air within the respective temperature adjusting area. The respective temperature adjusting area is referred to herein as a temperature adjusting chamber. The temperature adjusting chamber in this embodiment is referred to as a heating chamber. An example of the air heating unit is a hot air blower (also referred to as an air heat blower). The vessel 310, 10 is placed within the heating chamber. Typically, the heating chamber is a closed chamber. The heating chamber may be, for example, the area bounded by horizontal surfaces 386 and 387, front surface wall 388, side surface wall 389, a back surface wall (not shown, that is substantially parallel to front surface wall 388), and a side surface wall (not shown, that is substantially parallel to side surface wall 389). Optionally, these bounding walls/surfaces may comprise valves, sliding doors, etc., in order to form a substantially closed system to maintain the heat therein (however the chamber may be heated even without valves, sliding doors, etc.,). The air heating unit is coupled to the interior of the heating chamber. The air heating unit has appropriate piping that is configured to lead the hot air stream to an inlet at the heating chamber (e.g., the inlet being an opening through one of the bounding walls/surfaces) so that the hot air will enter the heating chamber. The heating chamber may also comprise an appropriate outlet. Optionally, the outlet may lead back (by piping) to the air heating unit for circulation (according to some particular embodiments) thereby providing an efficient heating circulation, as known in the art. The hot stream of air contributes to heating the vessel 310, 10 exterior and thereby heating the ingredients and/or puree within the vessel 310, 10 to prevent formations of bacteria coliforms, salmonella, etc., and to enable serving a hot puree dish. The air heating unit is coupled to the system control unit and power unit. The air heating unit is preferably set (as known in the art) to heat the heating chamber to a temperature which will cause the puree within the vessel 310, 10 to be at the desired temperature.

According to another embodiment of the present invention, the present invention temperature adjusting unit may be an air cooling unit (not shown), configured to create and supply a cold air stream, and to pass the cold air into a respective temperature adjusting area to reduce the temperature of the air within the respective temperature adjusting area. The respective temperature adjusting area is referred to herein as a temperature adjusting chamber. The temperature adjusting chamber in this embodiment is referred to as a cooling chamber. An example of the air cooling unit is a cold air blower. The vessel 310, 10 is placed within the cooling chamber. Typically, the cooling chamber is a closed chamber. The cooling chamber may be, for example, the area bounded by horizontal surfaces 386 and 387, front surface wall 388, side surface wall 389, a back surface wall (not shown, that is substantially parallel to front surface wall 388), and a side surface wall (not shown, that is substantially parallel to side surface wall 389). Optionally, these bounding walls/surfaces may comprise valves, sliding doors, etc., in order to form a substantially closed system to maintain the cold air therein (however the chamber may be cooled even without valves, sliding doors, etc.,). The air cooling unit is coupled to the interior of the cooling chamber. The air cooling unit has appropriate piping that is configured to lead the cold air stream to an inlet at the cooling chamber (e.g., the inlet being an opening through one of the bounding walls/surfaces) so that the cold air will enter the cooling chamber. The cooling chamber may also comprise an appropriate outlet. Optionally, the outlet may lead back (by piping) to the air cooling unit for circulation (according to some particular embodiments) thereby providing an efficient cooling circulation, as known in the art. The cold stream of air contributes to cooling the vessel 310, 10 exterior and thereby cooling the ingredients and/or puree within the vessel 310, 10 to prevent formations of bacteria coliforms, salmonella, etc. Cooling the ingredients and/or puree below a certain temperature also prevents formations of bacteria coliforms, salmonella, etc. The air cooling unit is coupled to the system control unit and power unit. The air cooling unit is preferably set (as known in the art) to cool the cooling chamber to a temperature which will cause the puree within the vessel 310, 10 to be at the desired temperature.

According to an embodiment of the present invention, temperature sensors (also coupled to the control unit and the power unit) may be attached to the interior of the vessel 310, 10 in order to control the air heating unit/air cooling unit to maintain the heat/cold air at a predefined temperature, and in a cost efficient manner (e.g. turning off the air heating/cooling unit if the temperature exceeds/is below a certain temperature and turning it on if the temperature is lower/higher than a predefined temperature).

The present invention also relates to additional methods integrated with use of the system elements above. The present invention relates to a method for preparing and dispensing a puree comprising the following steps:

A) placing one or more ingredient dosages into a vessel to be blended in a blending cycle;

B) blending the one or more ingredients inside the vessel into a puree;

C) the method further comprises one of the following steps (C1 or C2):
C1) providing that said blending vessel is placed in a heating chamber (as described herein), heating the vessel by means of an air heating unit (as described herein) coupled to the interior of said heating chamber, such that the puree content is heated;
C2) providing that said blending vessel is placed in a cooling chamber (as described herein), cooling the vessel by means of an air cooling unit (as described herein) coupled to the interior of said cooling chamber, such that the puree content is cooled;

D) periodically dispensing a dosage of the puree content of step C;

E) periodically placing a consecutive group of one or more ingredient dosages into the vessel to be blended in a consecutive blending cycle and blending the consecutive group of one or more ingredient dosages inside the vessel into a puree, and returning to step C.

Preferably, step C is carried out simultaneously during one or more of the other steps.

Preferably, the dispensed puree dosage is leveled by vibrating the puree (e.g., by the vibrating surface as described herein).

Preferably, a step is carried out prior to step A comprising:

heating the ingredients within the container by means of a steam unit coupled to the interior of the container (as described herein).

Preferably, a step is carried out prior to step A comprising:

heating the ingredients within the container by means of heating elements.

Preferably, a step is carried out prior to step A comprising:

heating the ingredients within the container by means of heating elements attached to the container spiral assembly (as described herein).

Preferably, the method further comprises a step prior to transferring at least one of said ingredient dosages from a respective cartridge into the corresponding container, comprising:

heating the ingredients within the cartridge by means of a steam unit coupled to the interior of the cartridge (as described herein).

Preferably, the method further comprises a step prior to transferring at least one of said ingredient dosages from a respective cartridge into the corresponding container, comprising:

heating the ingredients within the cartridge by means of heating elements attached to the cartridge spiral assembly (as described herein).

While some of the embodiments of the invention have been described by way of illustration, it will be apparent that the invention can be carried into practice with many modifications, variations and adaptations, and with the use of numerous equivalents or alternative solutions that are within the scope of a person skilled in the art, without departing from the spirit of the invention, or the scope of the claims.

1. A system for preparing and dispensing a puree comprising:
a blending vessel;
a pulping element displaceable within said blending vessel, configured to blend ingredients into a puree;
wherein the bottom of said blending vessel comprises a first valve.

2. The system according to claim 1, wherein the pulping element is a spinnable blade element placed within the interior of said blending vessel.

3. The system according to claim 2, wherein the blade element is fixed to an upper arm element.

4. The system according to claim 1, further comprising a cup element comprising an open top portion which is attached to the external side of the bottom surface of the blending vessel;
wherein said cup element surrounds the first valve and said cup element's interior is beneath said first valve.

5. The system according to claim 4, wherein the bottom surface of the cup element comprises a second valve.

6. The system according to claim 1, further comprising one or more ingredient containers placed above the blending vessel.

7. The system according to claim 6, wherein each one or more ingredient container comprises an ingredient container valve at its bottom surface;
wherein said system comprises a transport path for each of the one or more ingredient containers extending from its respective ingredient container valve to a spatial area above the blending vessel or within the blending vessel.

8. The system according to claim 6, wherein at least one ingredient container comprises heating elements.

9. The system according to claim 5, further comprising an external housing comprising an opening leading to a cavity for placing a receiving dish therein, wherein a portion of the cavity is beneath the second valve.

10. The system according to claim 1, wherein the first valve comprises a sliding gate and a flexible sealing O-ring element;
wherein the sliding gate is configured to be placed in a valve closed position and in a valve open position;
wherein the vessel comprises a bottom opening;
wherein the O-ring is mounted on the bottom opening of said vessel; and
wherein when said sliding gate is in the closed position, said O-ring element is compressed and applies force on the top surface of said sliding gate, thereby providing a sealed passageway between the interior of said vessel and the top of said sliding gate.

11. The system according to claim 10, wherein the system further comprises a piston unit comprising an internal motor driving a piston rod;
wherein the sliding gate is slidable along tracks; and
wherein the piston rod is connected to the sliding gate.

12. The system according to claim 1, further comprising one or more ingredient containers placed above the blending vessel;
wherein each one or more ingredient container comprises an ingredient container valve at its bottom surface that comprises a sliding gate and a flexible sealing O-ring element;
wherein the sliding gate is configured to be placed in a valve closed position and in a valve open position;
wherein each one or more ingredient container comprises a bottom opening;
wherein the O-ring is mounted on the bottom opening of said one or more ingredient container; and
wherein when said sliding gate is in the closed position, said O-ring element is compressed and applies force on the top surface of said sliding gate, thereby providing a sealed passageway between the interior of said one or more ingredient container and the top of said sliding gate.

13. The system according to claim 12, wherein the system further comprises a piston unit comprising an internal motor driving a piston rod;
wherein the sliding gate is slidable along tracks; and
wherein the piston rod is connected to the sliding gate.

14. The system according to claim 12, wherein said system comprises a funnel element extending diagonally upwards from a portion of the vessel rim; and
wherein the ingredient container valves are placed above the interior space of the vessel or above said funnel element.

15. The system according to claim 2, wherein the blade element comprises one of the following: (a) two sharp edges; (b) two blunt edges; or (c) a sharp edge and a blunt edge; and
wherein the blade element is spinnable in a forward direction and in a backward direction.

16. The system according to claim 2, wherein the blade element comprises two rotatable blades and a third smaller bottom rotatable blade.

17. The system according to claim 3, wherein said system further comprises:
a motor for driving the rotation of the blade element;
a first pulley mounted on a first spinning axle spinnable by said motor;
a second pulley mounted on a second spinning axle;
a timing belt mounted on said first pulley and said second pulley;
a coupling element comprising an upper coupling portion and a lower coupling portion;
wherein said lower coupling portion is mounted on an upper portion of the upper arm element;
wherein the upper coupling portion is connected to said second spinnable axle and vertically displaceable thereon between a high vertical position and a low vertical position; and
wherein said upper coupling portion is connectable to the lower coupling portion.

18. The system according to claim 17, wherein the upper coupling portion comprises a first group of recesses and a first group of bulging elements protruding downwards, and the lower coupling portion comprises a second group of recesses and a second group of bulging elements protruding upwards; and
wherein when the upper coupling portion is connected to the lower coupling portion:
a) the upper coupling portion first group of bulging elements are placed at corresponding recesses of the lower coupling portion second group of recesses and are complementary thereto; and
b) the lower coupling portion second group of bulging elements are placed at corresponding recesses of the upper coupling portion first group of recesses and are complementary thereto.

19. The system according to claim 18, wherein the upper coupling portion is part of a spring latch mechanism.

20. The system according to claim 17, wherein the second spinning axle comprises a vertical slit; and
wherein the upper coupling portion comprises a horizontal rod fixed thereon and placed through said vertical slit.

21. The system according to claim 17, wherein when the upper coupling portion is placed at the high vertical position:
a) the vessel is removable from said system; and
b) the vessel is insertable to said system by being mounted on corresponding fittings.

22. The system according to claim 1, comprising a mashing unit comprising:
a vertical arm configured to expand and contract vertically; and
a bottom mashing element connected to the bottom of said vertical arm and configured to be vertically displaceable within the interior of said blending vessel;
wherein the pulping element is said mashing element.

23. The system according to claim 6, wherein said system comprises a steam unit coupled to the interior of the one or more ingredient containers.

24. The system according to claim 1, further comprising a vibrating surface.

25. The system according to claim 1, wherein the blending vessel is placed within a temperature adjusting chamber wherein said system further comprises a temperature adjusting unit coupled to the interior of said temperature adjusting chamber; and
wherein the temperature adjusting unit is an air heating unit or an air cooling unit.

26. The system according to claim 6,
wherein at least one of the one or more ingredient containers comprises a mixing element.

27. The system according to claim 26, wherein the mixing element is an elongated spiral assembly.

28. The system according to claim 26, wherein the mixing element comprise heating elements attached thereon.

29. The system according to claim 26, wherein said system comprises a steam unit coupled to the interior of the one or more ingredient containers.

30. The system according to claim 1, wherein said system further comprises one or more cartridges each placed above the blending vessel or above a respective ingredient container;
wherein said one or more cartridges comprises a mixing element.

31. The system according to claim 51, wherein the mixing element is an elongated spiral assembly.

32. The system according to claim 30, wherein the mixing element comprises:
a spinning bar fixedly mounted on a spinnable axle;
at least one receptacle having an opening and a hollow interior, each receptacle fixedly connected to one edge of the spinning bar;
wherein the cartridge comprises a bottom valve having an opening; and
wherein the at least one receptacle opening is configured to face and surround the valve opening, when the spinning bar is in a certain spin position.

33. The system according to claim 30, wherein the mixing element comprises heating elements attached thereon.

34. The system according to claim 30, wherein said system comprises a steam unit coupled to the interior of the one or more cartridges.

35. The system according to claim 1, wherein the system comprises one or more heating elements attached to the blending vessel.

36. A system for preparing and dispensing a puree comprising:
a blending vessel;
a pulping element displaceable within said blending vessel, configured to blend ingredients into a puree;
wherein the bottom of said blending vessel comprises an opening coupled to a faucet or valve.

37. A method for preparing and dispensing a puree comprising the following steps:
A) placing one or more ingredient dosages into a vessel to be blended in a blending cycle;
B) blending the one or more ingredient dosages inside the vessel into a puree;
C) periodically dispensing a dosage of the puree content of step B;
D) periodically placing a consecutive group of one or more ingredient dosages into the vessel to be blended in a consecutive blending cycle and blending the consecutive group of one or more ingredient dosages inside the vessel into a puree, and returning to step C.

38. The method according to claim 37, further comprising a step after step B comprising:
heating or cooling the vessel such that its puree content is heated or cooled.

39. The method according to claim 38, wherein said method comprises:
providing that said blending vessel is placed in a temperature adjusting chamber, heating or cooling the vessel by means of an air heating/cooling unit coupled to the interior of said temperature adjusting chamber, such that the puree content is heated/cooled.

40. The method according to claim 37, wherein step A comprises transferring each of the one or more ingredient dosages from a corresponding container to the vessel.

41. The method according to claim 40, wherein said transferring comprises rotating a respective spiral assembly within a corresponding ingredient container.

42. The method according to claim 41, wherein the amount of a respective ingredient dosage transferred from the one or more ingredient dosages is proportional to the rotating of the respective spiral assembly.

43. The method according to claim 40, further comprising a step prior to step A comprising:
transferring at least one of said ingredient dosages from a respective cartridge into the corresponding container by rotating a spiral assembly within said respective cartridge.

44. The method according to claim 37, wherein the dispensing in step C is carried out until the dispensed puree reaches a predetermined weight.

45. The method according to claim 37, wherein the dispensed puree dosage is leveled by vibrating the puree.

46. The method according to claim 40, wherein a step is carried out prior to step A comprising:
heating the ingredients within the container by means of a steam unit coupled to the interior of the container.

47. The method according to claim 40, wherein a step is carried out prior to step A comprising:
heating the ingredients within the container by means of heating elements.

48. The method according to claim 41, wherein a step is carried out prior to step A comprising:
heating the ingredients within the container by means of heating elements attached to the container spiral assembly.

49. The method according to claim 43, further comprising a step prior to transferring at least one of said ingredient dosages from a respective cartridge into the corresponding container, comprising:
heating the ingredients within the cartridge by means of a steam unit coupled to the interior of the cartridge.

50. The method according to claim 43, further comprising a step prior to transferring at least one of said ingredient dosages from a respective cartridge into the corresponding container, comprising:
heating the ingredients within the cartridge by means of heating elements attached to the cartridge spiral assembly.
